(19) United States
(12) Patent Application Publication
(10) Pub. No.: US 2018/0096097 A1
(43) Pub. Date: Apr. 5, 2018

(54) METHOD AND SYSTEM FOR COMPARING PROTEINS IN THREE DIMENSIONS

(71) Applicant: University of Louisiana at Lafayette, Lafayette, LA (US)

(72) Inventors: Sumi Singh, Lafayette, LA (US); Vijay V. Raghavan, Lafayette, LA (US); Wu Xu, Lafayette, LA (US)

(21) Appl. No.: 15/725,663

(22) Filed: Oct. 5, 2017

Related U.S. Application Data
(60) Provisional application No. 62/404,412, filed on Oct. 5, 2016.

(51) Int. Cl. G06F 19/16; G06F 19/26; G06F 19/24

(52) U.S. Cl. CPC G06F 19/16; G06F 19/24; G06F 19/26

(57) ABSTRACT

A method of comparing three dimensional structure of polymers such as proteins is provided herein comprising the steps of developing at least one key of the protein wherein each said at least one key is based on a quintuple of features consisting of three non-collinear objects in said protein, a representative angle between the three non-collinear objects, and a representative edge length, and comparing the key to either a known database of keys or a key developed for another protein to determine the protein or run a comparison thereof.

### CROSS REFERENCE TO RELATED APPLICATIONS

This application claims priority to the Provisional U.S. patent application No. 62/404,412 entitled “Method and System for Comparing Proteins in Three Dimensions,” filed Oct. 5, 2016.

### STATEMENT REGARDING FEDERALLY SPONSORED RESEARCH OR DEVELOPMENT

Not Applicable.

### REFERENCE TO A “SEQUENCE LISTING,” A TABLE, OR A COMPUTER PROGRAM

Not Applicable.

### DESCRIPTION OF THE DRAWINGS

The drawings constitute a part of this specification and include exemplary embodiments of the Method and System for Comparing Proteins in Three Dimensions, which may be embodied in various forms. It is to be understood that in some instances, various aspects of the invention may be shown exaggerated or enlarged to facilitate an understanding of the invention. Therefore the drawings may not be to scale.

FIG. 1 is rendering of a TSR in 2-D as known in the art.

Table 1 is an embodiment of a method for rule-based label assignment.

Table 2 is a representative Angle Calculation.

FIG. 2 shows an embodiment of a triangular spatial relationship in 2-D for triple (i) in FIG. 1.

FIG. 3 is a depiction of the dataset for angle and length discretization for TSR-3D.

FIG. 4 is a drawing showing DFG motifs as seen in protein kinase.

Table 3 is a chart showing Human kinase dataset (S1).

Table 4 is a chart showing Kinase dataset (S2).

FIG. 5 is a graph showing distribution of selected keys in sequence.

FIG. 6 is a graph showing distribution of angles.

FIG. 7 is a graph showing distribution of lengths.

FIG. 8 is a graph showing sequence cluster sample (S1).

FIG. 9 is a graph showing sequence cluster on dataset (S2).

FIG. 10 is a graph showing structure cluster sample (S1).

FIG. 11 is a graph showing structure cluster sample (S2).

Table 5 is a chart showing paired membership for ideal classification for S1.

Table 6 is a chart showing paired membership for ideal classification for S2.

Table 7 is a chart showing paired membership for S1 as seen from clustering algorithm. Sequence classification is given in lower triangular matrix and structural classification is given in upper triangular matrix.

Table 8 is a chart showing paired membership for S2 as seen from clustering algorithm. Sequence classification is given in lower triangular matrix and structural classification is given in upper triangular matrix.

FIG. 12 is a chart showing DFG motif as seen in sequence alignment of sample S1.

Table 10 is a chart showing structural motifs found in kinase group AGC.

Table 11 is a chart showing structural motifs found in kinase group STE.

Table 12 is a chart showing structural motifs found in kinase group TKL.

Table 13 is a chart showing structural motifs found in kinase group CAMK.

Table 14 is a chart showing structural motifs found in kinase group CMGC.

Table 15 is a chart showing structural motifs found in kinase group TK.

FIG. 13 is a drawing showing TOP 1, TOP 2, TOP 3 search described. Objects with (T) marking are test instances. For black star, the instance with correct class is in TOP 1 of the search. For five-point grey star, the instance with correct class is in TOP 2 of the search. For grey triangle the instance with correct class is in TOP 3 of search.

### BACKGROUND

Proteins are macromolecules or natural polymers with relatively complex structural features. Many of these structural features provide proteins with functional attributes that are vital to biochemical reactions. The primary structure of a protein is its amino acid sequence. A set of 20 amino acids create repeating units within the protein structure. The folding and intermolecular bonding of amino acid units ultimately determine the protein's 3-D shape. Because the amino acid units can repeat several hundred times in a protein, proteins are dynamic and can fold into exceedingly complex shapes. Protein structure studies assist in the investigation of protein-protein interactions and give researchers insight into the biological processes of the cell. By comparing the structure of two proteins, the observer can collect functional annotation, drug-protein interactions, protein-protein interactions and substrate-protein interactions, analysis of active sites, and a plethora of data on critical biochemical activities taking place in a living organism. Thus, protein 3-D structure comparison is an important computational problem that has applications in, e.g., drug design and disease treatment. Developments in this field could lead to cures for a myriad of afflictions, such as cancer, through a better understanding of bio-cell processes.

An important step towards understanding protein functions involves making structure comparisons of a protein under study with proteins stored in the Protein Data Bank (“PDB”), a database of known protein and nucleic acid 3-D structures. As of February 2015, there were nearly 99,133 protein structures freely available in the PDB, which promises to accelerate scientific discovery in all areas of biological science, including biodiversity and evolution in natural ecosystems, agricultural plant genetics, breeding of farm and domestic animals, and human health and disease.

In this way, proteins under study may be arranged so as to identify regions of similarity with data bank proteins that may be of consequence functionally or evolutionarily. This process is called alignment. The degree of structural variation and the inherent flexibility of proteins are critical for their functioning. However, they also lead to enormous amounts of available PDB data. In order to make effective use of this vast amount of data, there is a growing need for more sensitive and automated computational methods for comparing, searching, and analyzing protein structures. Despite active research and the availability of a growing number of methods, there is no widely accepted 3-D structural alignment method. This leaves researchers without a method for searching the PDB with high success rates in finding true matches in the database.

Traditional protein structure comparison or alignment methods can be divided into two main types: sequence-dependent and sequence-independent methods. The results of sequence dependent and sequence independent structure comparison methods are highly correlated, with the exception of the distant homology cases. Sequence-dependent methods of protein structure comparison assume a strict one-to-one correspondence between the amino acids of the two proteins under comparison. In sequence-independent methods, structural superimposition is performed independently, followed by the evaluation of residue correspondence obtained from such a superimposition.

The current sequence-dependent and sequence-independent approaches for protein structure comparison fall into two categories: inter-atomic distance-based and the intra-atomic distance-based. These methods are alignment-based protein structure comparison methods and are based on measuring the distance between two points. For inter-atomic distance-based approaches, the first step is to obtain skeletons for each structure and then select representative points for each skeleton. In the next step, rotation and translation are performed to superimpose points and calculate distance between corresponding points in order to obtain information on protein similarity.

For intra-atomic distance-based approaches, the first two steps are almost identical to inter-atomic approaches: obtain the protein skeleton and representative points. But this family of approaches does not require rotation or translation; instead, it generates a set of matrices representing all the distances between all pairs of points. Structure information is converted to a distance matrix and then a search for similar submatrices is performed. If two matrices are similar, it implies that two structures are similar. If two submatrices are similar, it implies that certain parts of two structures are similar.

These current methods are either computationally expensive because they are based on structural alignment, or do not capture the subtleties of the protein 3-D structure. The inter-atomic and intra-atomic distance methods are both used mainly for global 3-D structure comparison of two or more proteins with similar amino acid sequences and similar size. These methods cannot be used to identify similar local structures if the global 3-D structures of the proteins being compared vary. Also, the methods are incapable of locating sequentially non-conserved, but structurally conserved, subunits of a protein.

A novel method is provided herein that addresses, inter alia, these short-coming by converting 3-D structure information into geometric information, rather than to distance information between two points. The novel method models the global and local structure of proteins in three dimensions. The 3-D modeling is used to compare the structures across proteins using triangular spatial relationship (“TSR”). By doing so, one or more embodiments of the instant method is capable of providing one or more improvements over the prior art, including, in various embodiments: (a) structural representation that incorporates primary structure information from amino acids and 3-D structure information through angular orientation and edge distance; (b) transformation of each structural unit into a unique key via a transformation function that is deterministic, rotation and translation invariant and scale sensitive; (c) design of an approach that leverages the proposed protein 3-D structure representation method to obtain a structural comparison method to discover the conserved structural motifs that are hard to find through sequence alignment; (d) application of the proposed protein structure comparison method in order to find functional clusters and hierarchical classification; and, (e) a fast implementation and querying method to perform protein comparison along with visualization.

The novel method described herein incorporates TSR. TSR has been previously used for 2-D symbolic image comparisons (where each TSR is represented by a quadruple of features). The method modifies the previous 2-D comparison by introducing the concept of scale sensitive TSR 3-D keys that are represented by quintuples of features, and a novel equal frequency discretization method, called Adaptive Unsupervised Iterative-Discretization (“AUI-Dis”), to obtain unique keys. AUI-Dis adaptively chooses the bin (partition representing an interval of values) size to ensure that all the instances of same value occur in the same bin. AUI-Dis iterates over several possibilities of number of bins before it chooses the optimal number of bins that minimizes the variability in bin frequencies. It performs unsupervised equal frequency binning to ensure that the probability of a random variable being located in any one bin is uniform. This feature has previously been unavailable in known equal-width binning algorithms.

After discretizing length and angles of the protein structure, and extracting the quintuples from the protein structure files, the keys and their values are extracted. A key is the result of transforming a structural unit into a unique integer. The key value is the number of times that a unit has repeated in the entire protein structure. The advantage of keys generated using the TSR 3-D algorithm is that it is deterministic and sensitive to scaling, but invariant to rotation and translation. These properties have been proved theoretically and experimentally. These keys are, thus, an accurate representation of protein 3-D structures. The pairwise protein 3-D structure comparison method using keys generated by TSR 3-D can be useful to generate a structural similarity map and to give a ranked similarity output (using, e.g., the Generalized Jaccard Coefficient) by searching a database of proteins with respect to a given query protein structure.

### DETAILED DESCRIPTION

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies. Although the terms “step” or temporal indicators such as “then”, “next,” etc. might be used herein to connote different components of methods or systems employed, the terms should not be interpreted as implying any particular order among or between various steps herein disclosed unless and except when the order of individual steps is explicitly described.

Furthermore, the described features, structures, or characteristics may be combined in any suitable manner in one or more embodiments. In the following description, numerous specific details are provided, such as examples of algorithms, database sets of proteins, key numbers, key sets, and amino acids. One skilled in the relevant art will recognize, however, that the instant Method for the Three Dimensional Comparison of Proteins may be practiced without one or more of the specific details, or with other methods, components, materials, and so forth. In other instances, well-known structures, materials, or operations are not shown or described in detail to avoid obscuring aspects of the invention. Likewise, although the subject matter is directed to protein comparison, it is understood and intended that this method could be used to analyze and compare a multitude of natural or synthetic polymers or molecules with 3-D shapes other than proteins.

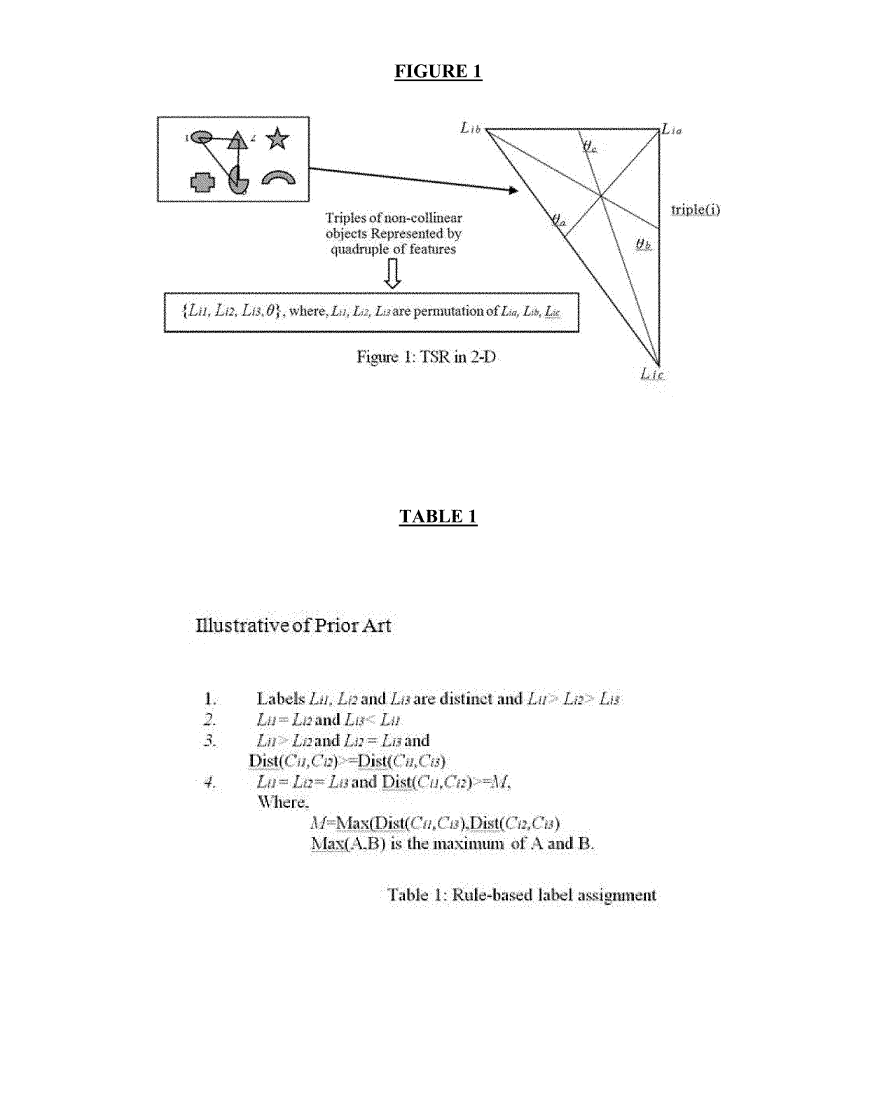

A method for comparing 3-D protein structure is provided herein using a novel, significantly modified triangular spatial relationship (“TSR”) comparison process. Traditionally, TSR has been used only for 2-D symbolic image representation (i.e., an abstract representation of object relationships in an image). The 2-D TSR method for symbolic images can be used to find global similarity between two symbolic images. The method is based on the relations between three non-collinear objects in a given symbolic image. This local relationship is described by a quadruple of features: three labels used to identify the objects and a representative angle between them (see FIG. 1). TSRs are extracted to generate signatures of images that can be used to establish a signature-based symbolic image database. These image signatures can then be used to compute similarity between two images or retrieve similar images with respect to a query image. The original TSR-based method for similarity computation and retrieval is suitable for symbolic images that have just two dimensions (x, y).

TSRs between objects in a symbolic image are defined by giving relationships between all possible combinations of three non-collinear objects taken in a triple. These objects themselves are represented by unique numerical labels and the spatial relationships between them are represented by an angle (θₐ, θ_{b}, θ_{c}, in FIG. 1). The centroid of these objects form the vertices of a triangle shown in in FIG. 1.

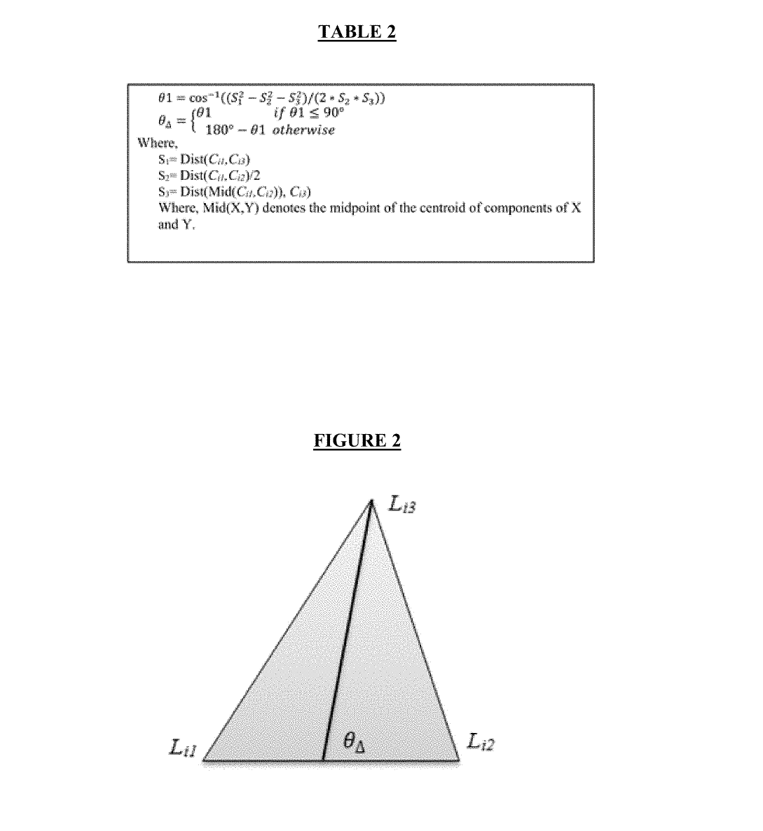

Prior to angle calculations, rule-based label arrangement (according to Table 1) is performed to ensure the uniqueness of the representative TSR. For example, FIG. 2 depicts a triple (i) with the sequence of labels Lᵢₐ=1, L_{ib}=2 and L_{ic}=3. After rule-based label arrangement, the Lᵢₐ, L_{ib} and L_{ic}, are rearranged onto Lᵢ₁=1, Lᵢ₂=2 and Lᵢ₃=3, respectively. Lᵢ₁, Lᵢ₂ and Lᵢ₃ satisfy one of the conditions of Table 1, where i₁, i₂, and i₃ are the corresponding objects in triple and Cᵢ₁, Cᵢ₂, and Cᵢ₃ are the corresponding centroids.

The representative angle is calculated based on label arrangements as given in Table 2. And the TSR between the objects in triple (i) is given by a quadruple of variables {Lᵢ₁, Lᵢ₂, Lᵢ₃, θ_{Δ}} as shown in FIG. 2. This quadruple of variables is used to calculate a unique integer valued key (k) as given by the following transformation function:

k=D(Lᵢ₁−1)m²+D(Lᵢ₂−1)m+D(Lᵢ₃−1)+(θ−1) Equation 1

where, m is the total number of distinct labels; θ is the class value (a “class” as used herein is a set of triples with similar angles or lengths and is also referred to as a “discretization level”) for the class in which θ_{Δ} fails to achieve discretization; and D is the total number of discretization levels. Since all these values are integers, the final key, k, is an integer as well. Integer keys are computationally simpler to work with when compared to the non-integer keys. Each one of the derived keys uniquely identifies a sub-structure.

Representation of 2-D images using TSR results in rotation invariant, translation invariant, and scale insensitive transformation. Although these properties are desirable for image (2-D) representation, they are not all desirable for protein 3-D structure representation. As the sub-structural similarities are indicative of functional relationships, it is problematic if two sub-structures are represented by the same key if they have different sizes or differ in scale. This makes scale sensitivity a desirable property for protein 3-D structure representation. For this reason, significant modifications to the concept of 2-D TSR are required to ensure the representation is scale sensitive.

### TSR—3D

Although TSR has been shown to be useful to represent object relationships in a 2-D image, proteins are 3-D macromolecules, and the structure of a protein is critical to its function and understanding. Therefore, the present invention generalizes TSR 2-D to represent object relationships in 3-D. The novel method described herein uses keys generated through TSR 3-D to compare the 3-D macromolecules. A transformation method that maps the 3-D protein structure information into a vector of keys has been used. These keys together represent an entire protein 3-D structure and can be used to compare 3-D structures of different proteins.

For the purposes of illustrating an embodiment of the Method for 3-D Comparison of Proteins, it is of interest to generalize TSR to represent protein structures in 3-D. Proteins are made up of some permutation of 20 amino acids with repetitions. In this embodiment, these 20 amino acids in a sequence are analogized to objects in an image, such that triples of amino acids in the protein 3-D structure of a protein molecule can be considered as the three vertices of a triangle in 3-D. A quadruple of a triple of amino acids of a protein structure in 3-D, obtained using Table 1, Table 2, and Equation 1 as modified herein, can uniquely represent the spatial relationships between those amino acids in 3-D.

Even though proteins are complex structures, the skeleton of the protein is not as complex and still provides the necessary level of sensitivity to identify the protein. This is because each point in the protein structure is represented by the coordinates of the Ca atom (a certain carbon atom joining two amide planes). Each atom is a part of an amino acid. Amino acids bond with each other through peptide linkage resulting in polypeptides or proteins. These linkages or bonds bear specific characteristics of planarity and rigidity and; therefore, have important implication on the structure of a protein by restricting the rotational freedom of the protein to Ca atoms of amino acids. Thus, the skeleton of protein can be adequately used to represent the overall structure of the protein. The protein skeleton is formed by Ca atoms of every amino acid forming the protein. Algorithms that have been established for use in the prior art for finding structural similarity between objects of 2-D images can be transformed to 3-D structures.

TSR for 3-D protein structures is defined by quintuples (rather than the previous quadruple) of features representing triples of amino acids. Before describing the quintuple of features representing a TSR of a protein 3-D structure, it is necessary to define a few concepts and terms. Set x is the set of names of amino acids, where |x|=20. “Labels” are unique continuous numerical values assigned to each amino acid. The set of labels, L, is an ordered set of continuous positive integers and is of same cardinality as x. So that L≤Z⁺, |L|=20, F: x->L and |x|=20. If, aₖϵx, then, F(aₖ)=Lₖ. A “triple” of amino acids tᵢϵt, belongs to a set of all possible combinations with repetition, of three amino acids so: aᵢₖ, aᵢₗ, aᵢₘϵx. “Centroid” (C) of an amino acid in triple tᵢ, is given by its representative center, Cα. Often, the centroid is also referred to as the geometric center, center of mass or center of gravity of the object.

The function of a protein changes if the size of the protein is varied. Thus, the novel method takes into account class length. The TSR of the current embodiment includes a quintuple of (five) features. The quintuple includes, three non-collinear amino acids forming the three vertices of a triangle (Lᵢ₁, Lᵢ₂, Lᵢ₃), arranged based on rules given in Table 1. The representative angle, θ_{Δ}, calculated using Table 2 forms the fourth variable of quintuple. A representative distance, D (or “edge length”), for scale sensitivity is given by the distance between Cᵢ₁ and Cᵢ₂. Thus the quintuple of features is given by: {Li₁, Li₂, Li₃, θ_{Δ}, D}. In this way, the key transformation function becomes:

k=θ_{T}d_{T}(lᵢ₁−1)m²+θ_{T}d_{T}(lᵢ₂−1)m+θ_{T}d_{T}(lᵢ₃−1)+d_{T}(d−1)+(θ−1) Equation 2

where m is the total number of distinct labels, θ, is the class value for the class in which θ_{Δ} falls to achieve discretization, θ_{T}, is the total number of distinct discretization level for angle representative, d, is the class value for the class in which D fails to achieve discretization, and d_{T}, is the total number of distinct discretization level for the representative length (or edge length).

Amino acids have natural semantic categorization which can be based on one or more properties such as size, structure, polarity, aromatic, aliphatic, charge, etc. In one or more embodiments, Equation 2 can be modified to reflect a natural categorization of amino acid. Let N contain labels associated with various amino acids categories so that: N⊂Z⁺, f:x N. If, aₖϵx, then, f(aₖ)=Nₖ. For triple tᵢ, rule-based arrangement of labels of categories is performed as in Table 1 and representative angle calculation is done as described in Table 2. The quintuples of features for generalized TSR 3-D becomes: {Nᵢ₁, Nᵢ₂, Nᵢ₃, θ_{Δ}, D}. Thus, the TSR 3-D key function incorporates the natural semantic categorization of amino acids and is given by the following transformation function:

k=θ_{T}d_{T}(Nᵢ₁−1)ν²+θ_{T}d_{T}(Nᵢ₂−1)ν+θ_{T}d_{T}(Nᵢ₃)+d_{T}(θ−1)+(d−1) Equation 3

where, ν is the distinct number categories into which amino acids are grouped. For example, let aliphatic, aromatic, charge, polarity, size, and structure, be the categories into which amino acids can be categorized. The representative positive integer values assigned to these categories could be 1, 2, 3, 4, 5 and 6 in the same order. All the amino acids that are aliphatic will be assigned the label 1, all the amino acids that are aromatic will be assigned the label 2 and so on. The illustrative number of distinct categories or (ν) is equal to six. It must be noted, the assumption in this example is that no amino acid may be simultaneous part of two categories.

Quintuples representing TSR 3-D (as given in Algorithm 1) are assigned a unique integer (key) value by using a hash function (a hash function projects a value from a set with many members to a value from a set with a fixed number of fewer members). In one or more embodiments, the functional mapping of TSR 3-D to a key value may be deterministic (two keys will always be the same if and only if the two representative quintuples are the same), insensitive to rotation and translation, and/or sensitive to scaling. Scale sensitivity is introduced so that the TSR 3-D keys represent the structure accurately.

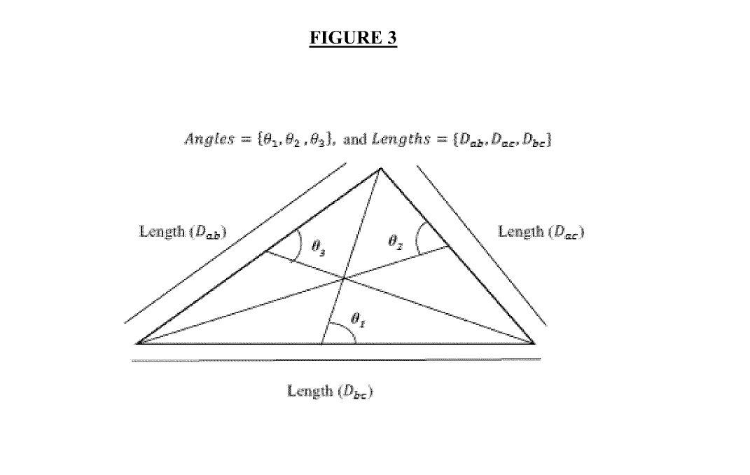

According to Algorithm 1, a set of 20 amino acids is given a single letter abbreviation (A-V). Each amino acid is represented by the x, y, and z coordinate of the centroid as depicted in FIG. 3. A triple of amino acids belongs to the set of all possible combinations with repetition, of three amino acids. Within the triple, a label is assigned to each amino acid. The “labels” are unique continuous numerical values. The set of these labels is an ordered set of continuous positive integers that are have the same cardinality. Next, according to Algorithm 1, rule-based assignment is performed to ensure the uniqueness of the representative TSR. Rule based arrangement is carried out as follows: Let l₁, l₂ and l₃ be the labels assigned to each amino acid aₘ, aₙ, aₚ {where, let m=1, n=2, and p=3} of triple tᵢ. Let d₁₂, d₁₃, d₂₃ be the distance between the respective amino acid centroid. Based on these assignments, one of the equations in Algorithm 1 Step 4 must be met. After performing the rule based arrangement, the representative angle can be calculated according to the formula in Algorithm 1 Step 5. The last step in generating the quintuple of features is to designate a representative length which is the distance between two centroids as shown in FIG. 3. Thus, the quintuple of features generated is: {Li₁, Li₂, Liₐ, θ_{Δ}, D}.

### Discretization

After determining the representative length (distance between centroids) and angle (calculated according the equation in Algorithm 1 Step 5) data as described above, that data can be discretized into bins to maximize the coherence of the data grouped together. Those skilled in the art would recognize that there are several methods for discretization when class labels are available, but for data where there is no prior knowledge of class membership, one may use equal width binning or equal frequency binning. The benefit of using equal frequency binning is that there is equal probability of a random unknown instance to fall in any of the bins, reducing extreme biases. A drawback associated with equal frequency binning is the possibility of same observed value to be assigned to different bins because of a sharp cut off as soon as the frequency criteria is fulfilled. Another inherent drawback is the inability of the binning algorithm to place all the occurrences of same value in one bin. To overcome this drawback a new method called adaptive unsupervised iterative discretization (“AUI-Dis”) is used. AUI-Dis ensures that all occurrences of the same value are binned together, while maximizing the bin coherence. In one embodiment, Algorithm 2 is used to find the optimal discretization levels for length and angle using AUD-Dis. Algorithm 2 describes calculating the maximum number of bins to perform iterations using a known formula, computing the expected frequency, minimizing the overall variance of all bins for a given iteration, and choosing the optimal umber of bins for which the partition variance is minimum. D (representative length) and θ_{Δ} (representative angle) are discretized to find the discretization level, d and θ. The result of AUD-Dis is the number of discretization levels and respective bin boundaries, d_{T} and θ_{T}.

The key equation calculated according to the AUD-Dis method and as described in Algorithms 1 and 2 becomes (variables as defined above):

k=θ_{T}d_{T}(lᵢ₁−1)m²+θ_{T}d_{T}(lᵢ₂−1)m+θ_{T}d_{T}(lᵢ₃−1)+d_{T}(d−1)+(θ−1) Equation 2

Once the TSR 3-D keys (k) are computed according to Equation 2, the generated keys are used to compare proteins. The pairwise protein 3-D structure comparison method using keys generated by TSR 3-D can be useful to generate a structural similarity map and to give a ranked similarity output (using, e.g., the Generalized Jaccard Coefficient) by searching a database of proteins with respect to a given query protein structure. The TSR values of two protein 3-D structures p₁ and p₂ are considered as a weighted vector of keys. Equivalence ϵ for a given key kᵢ in two different proteins p₁ and p₂ is defined by Equation 4. The difference z for a given key kᵢ in a pair of proteins is given by Equation 5.

ϵᵢ=kᵢ^{p}^{₁}∩kᵢ^{p}^{₂} Equation 4

zᵢ=kᵢ^{p}^{₁}∪kᵢ^{p}^{₂} Equation 5

The variables in Equations 4 and 5 are: ∩ is the minimum weight of the same keys and ∪ is the maximum weight of the same keys. The Generalized Jaccard coefficient measure is proposed to calculate the similarity between two proteins represented. The Generalized Jaccard similarity coefficient is given by Equation 6, where n is the total number of unique keys in proteins p₁ and p₂, and ϵᵢ and zᵢ are obtained from Equations 4 and 5 respectively.

$${Jac}_{gen} = {\sum }_{i = 1}^{n} {ϵ}_{i} / {\sum }_{i = 1}^{n} {z}_{i} \qquad Equation 6$$

There can be other embodiments, where the individual terms of the summation in the numerator and the denominator are given weights and a weighted summation is done. In one or more embodiments, instead of summing over all n keys, a process for key set reduction may be applied.

### Structural Motifs

In one or more embodiments, the present method may be used to discover and compare structural motifs within proteins. Proteins that are evolutionarily conserved are called homologous. Homologous proteins have been found to have similar overall function. However, at micro level, a set of homologous proteins may exhibit some distinct functionality. The difference in functionality is a result of the presence of a unique functional group that is masked in the overall homology of the proteins. Previous methods of discovering functional groups performed sequence alignment and then looked for conserved groups of amino acids. However, structure is a better indicator of functionality than sequence. Thus, a phylogeny tree (as known in the art) is used for clustering similar protein groups as functional groups.

Experiments were conducted to show that the TSR 3-D keys that follow mean absolute deviation (“MAD”) in a given subset of homologous and distant homologous proteins represent functional groups within that proteins subset. These keys can also be used to find structurally conserved units or motifs. Two sets of protein kinases, the first belonging to humans (homo sapiens), and the second belonging to various organisms considered distant homologs were tested. The clustering of different functional groups was superior in the homologous proteins compared to that of the distant homologs because the former is more similar in terms of their sequence arrangements. Pairwise correctly and incorrectly placed cluster analysis was performed to compare the sequence and structure clusters. For the two datasets the TSR 3-D-based structure clustering method outperformed the sequence grouping method by 8% and 35%. The TSR 3-D algorithm was tested for its ability to localize the motifs as described below. The algorithm accurately localized the Asp-Phe-Gly (“DFG”) motifs in a group of proteins (DFG proteins belong to the kinase family.). The novel method can also identify local similarity and structural motifs (that is, conserved local sub-structures) within homologous and distant homologous proteins, unlike structure alignment methods.

To test the system, proteins structures are represented using key-value pairs extracted from their structural units. The key is the result of transforming a structural unit into a unique integer as described above and in one embodiment, in Algorithm 1. The key value is the number of times that a unit has repeated in the entire protein structure. Since a protein structure is represented using all possible combinations of triples of amino acids, the number of representative keys per protein structure is relatively high and calls for reduction. Many methods are known in the art to use in conjunction with dimensionality reduction, such as MAD. MAD values are used to identify motifs or portions of a protein shared by all proteins belonging to a class, S. It is based on how much weight values vary for a key within the class. If for a few keys, all proteins of a class have same value of weight, then the deviation in the weight values, as measured by MAD, is zero. Thus, MAD is calculated using the following equations:

$$\begin{matrix}{m}_{k} = 1 / n {\sum }_{i = 1}^{n} {k}^{{p}_{i}} & Equation 7 \\ {MAD}_{k} = 1 / n ( {\sum }_{i = 1}^{n} \vert {k}^{{p}_{i}} - {m}_{k} \vert ) & Equation 8\end{matrix}$$

Where mₖ is the mean for count key k, n is the sample size or the number of proteins in S, k^{p}^{ᵢ} is the weight of key k in protein i of sample S, and MADₖ is the mean absolute deviation of protein k in sample S.

In this embodiment, the keys selected from the reduction are then used for creating clusters of functional groups. These structural clusters can then evaluated against the sequence-based clusters and the former is expected to perform at least to the same degree of accuracy if not higher than the sequence clusters.

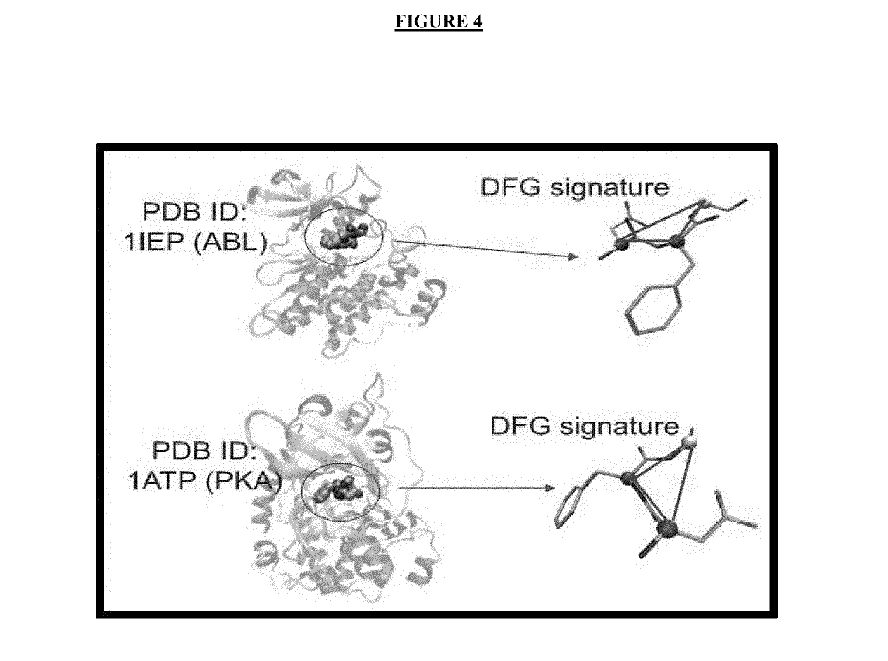

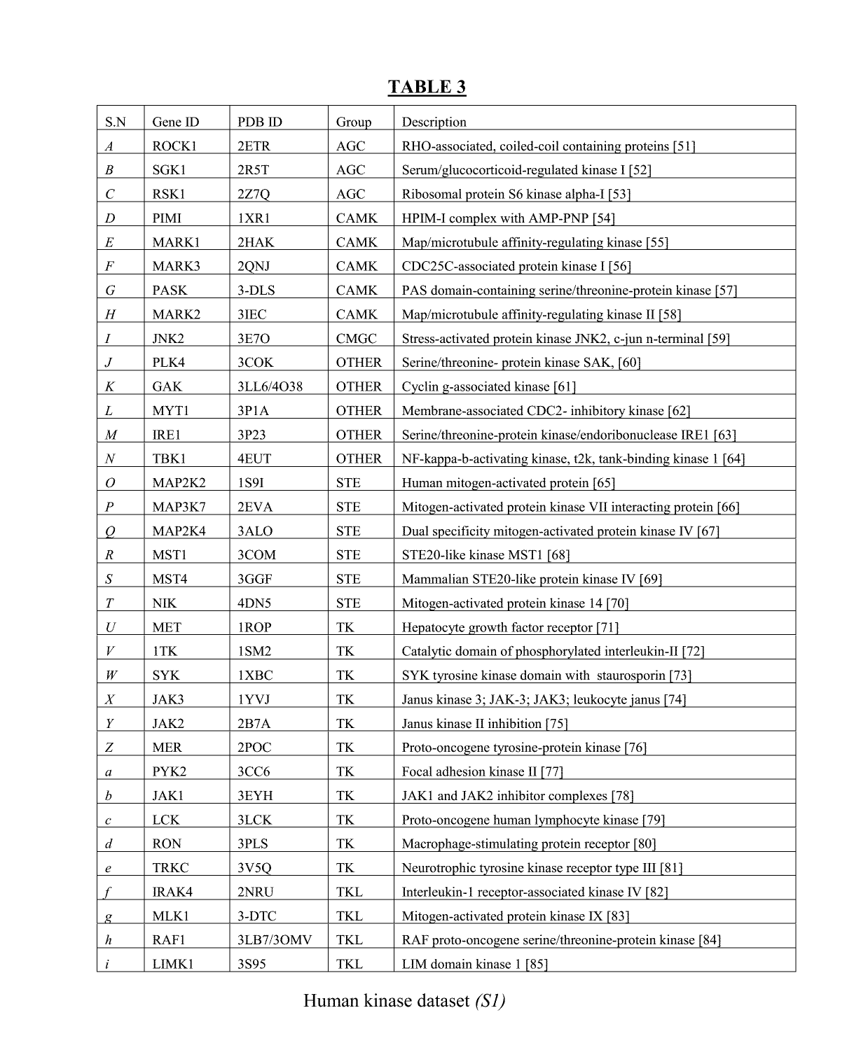

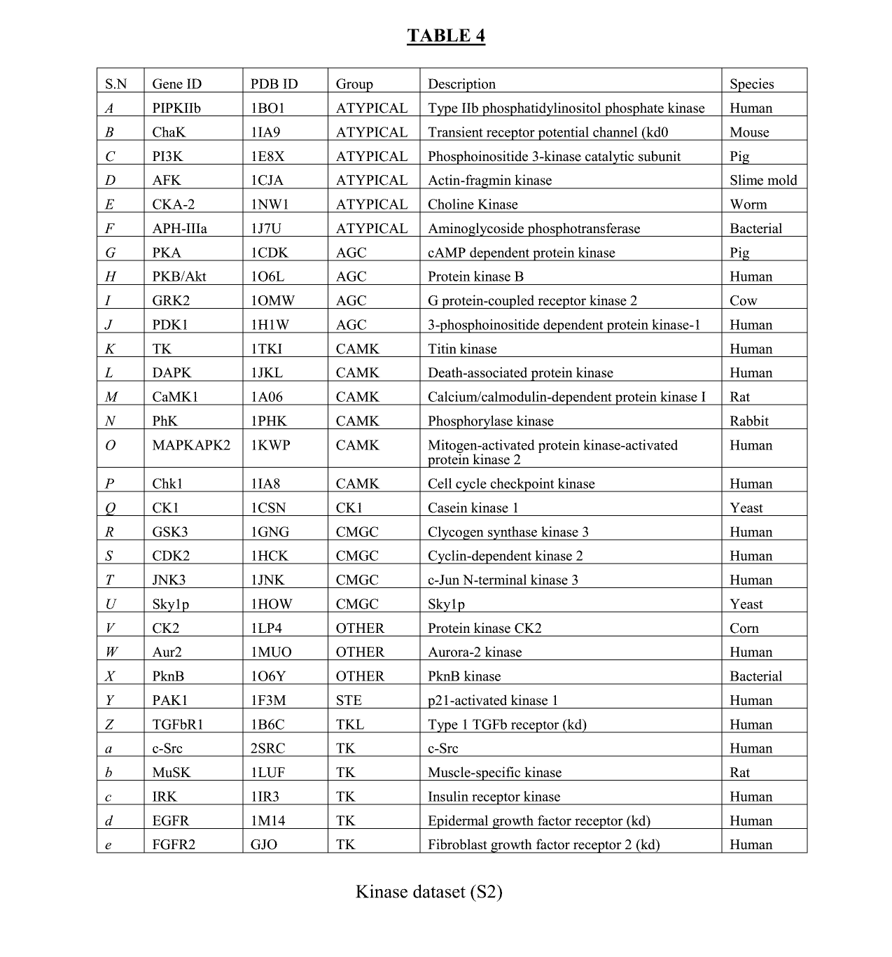

In a majority of protein kinases, there exists a conserved three-amino acid motif at the N-terminal of the flexible activation loop (DFG motif depicted in FIG. 4). This motif is an evolutionarily conserved triple of amino acids. Keys representing evolutionarily conserved functional units, such as the DFG, follow distribution of a low MAD—less than 0.5 across various proteins within the sample. The key representing DFG in a protein kinase also has low frequency of occurrence in each protein in which DFG is present.

MAD is used in the present example because it is a robust estimator of dispersion that is more resilient to outliers in a dataset, although it is understood that other methods and known formulas for estimating dispersion can be used. But with MAD, the effect of outliers is reduced because the deviation from the mean is not squared.

### Example 1

Two-sample datasets from the kinase family have been selected to test the ability of TSR 3-D keys to correctly identify the familial clusters. The first dataset consists of human kinase proteins (“S1”) as set forth in Table 3. S1 is made of randomly selected thirty-five human kinase from PDB. In most protein kinases, a conserved three-amino acid motif, Asp-Phe-Gly (“DFG”) exists at the N-terminal of the flexible activation-loop. S1 was extracted directly from PDB and the chain A was used to establish kinase domain structure. Proteins in the PDB contain one or more polypeptides. Each polypeptide is designated as chain A, B, C, D, E, F, and so on. The 35 human protein kinases (dataset S1) used contain either only chain A or chain A with other chains: B, C, D, and so on. For this specific dataset, chain A is the polypeptide that has kinase activities. S1 was extracted directly from the PDB and the chain A was used for key calculations to represent kinase structures.

The second kinase dataset (“S2”) consists of thirty-one kinases of various organisms. PDB-like structure files for S2 were obtained from the SCOP-ASTRAL 2.03 database. As S2 is taken from a previously published work, no test for percentage sequence similarity was performed on it.

The description of dataset S1 is given in Table 3. The kinase in S2 belong to different organisms is described in Table 4. The descriptions include a unique case-sensitive letter assignment to each kinase in the two samples. Because all the proteins in S1 are human proteins, a description on species is not necessary.

The selection of TSR 3-D keys is important. In this embodiment, the selection is based on the MAD with the parameters that selected keys must pass the maximum requirement of frequency of occurrence in the sample—i.e., document frequency (ν) computed based on the number of documents in which the key occurs, and the cutoff, (w) for MAD. The latter is computed using the distribution of the value of the given key across all the proteins in the sample. Algorithm 3 describes one embodiment of the key selection process using MAD. By using MAD, the protein is represented by a lower dimensional vector consisting of locally intersecting keys.

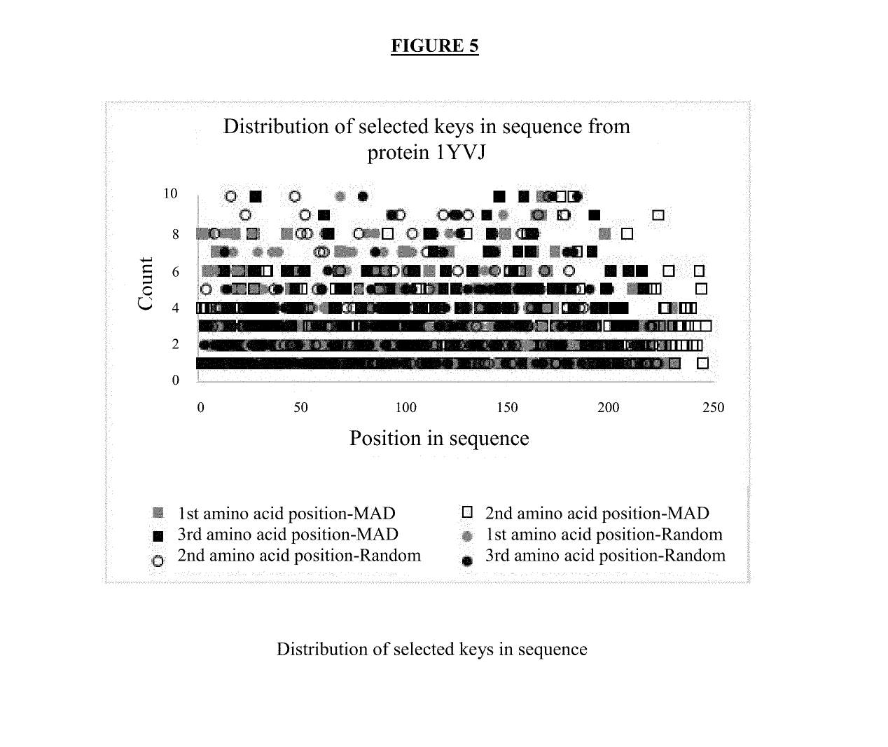

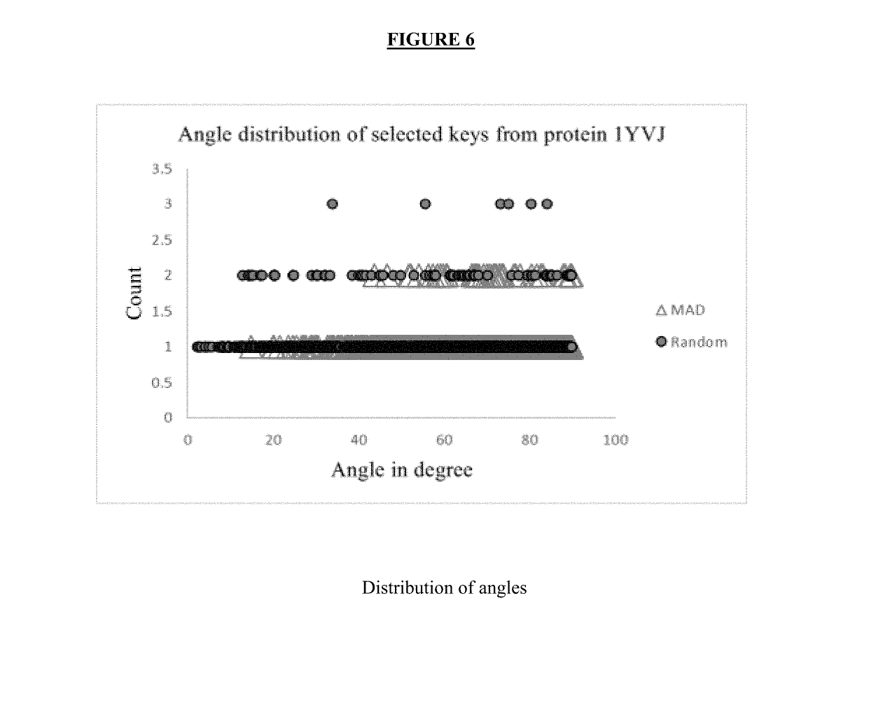

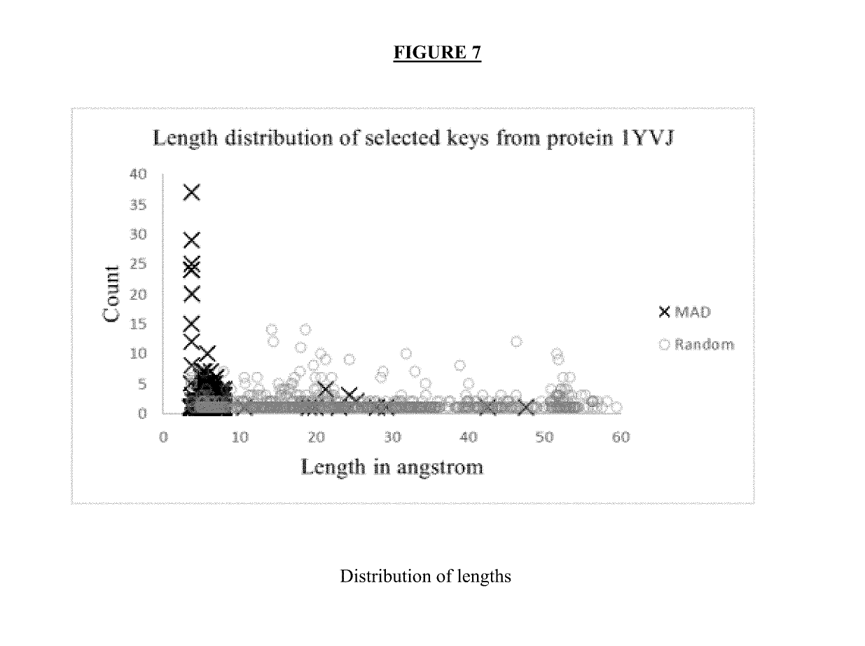

Evaluation of TSR 3-D features that form keys based on MAD criterion against randomly selected keys were performed for keys from four proteins randomly selected from sample S={S1, S2}. FIG. 5 gives the distribution of position of amino acids in the sequence for the selected triples. The distribution of first, second and third amino acids in every selected triple for both MAD is plotted as well as random triples. Similarly, FIG. 6 and FIG. 7 give the distribution of representative angles and lengths of the selected keys. The distributions of amino acids forming the keys in the sequence and the angles representing the corresponding TSR 3-D, were found to be same for both sets of keys as seen in FIG. 5 and FIG. 6.

The distribution of length of the keys selected by MAD were concentrated between 0 to 10 angstrom, whereas for randomly selected keys it was found to be scattered. FIG. 7 shows the distribution of representative lengths for the MAD selected keys (X) and randomly selected keys (o). FIG. 5, FIG. 6, and FIG. 7 show the results from single protein (PDB ID: 1YVJ) for clarity. Similar results were seen with other randomly sampled proteins.

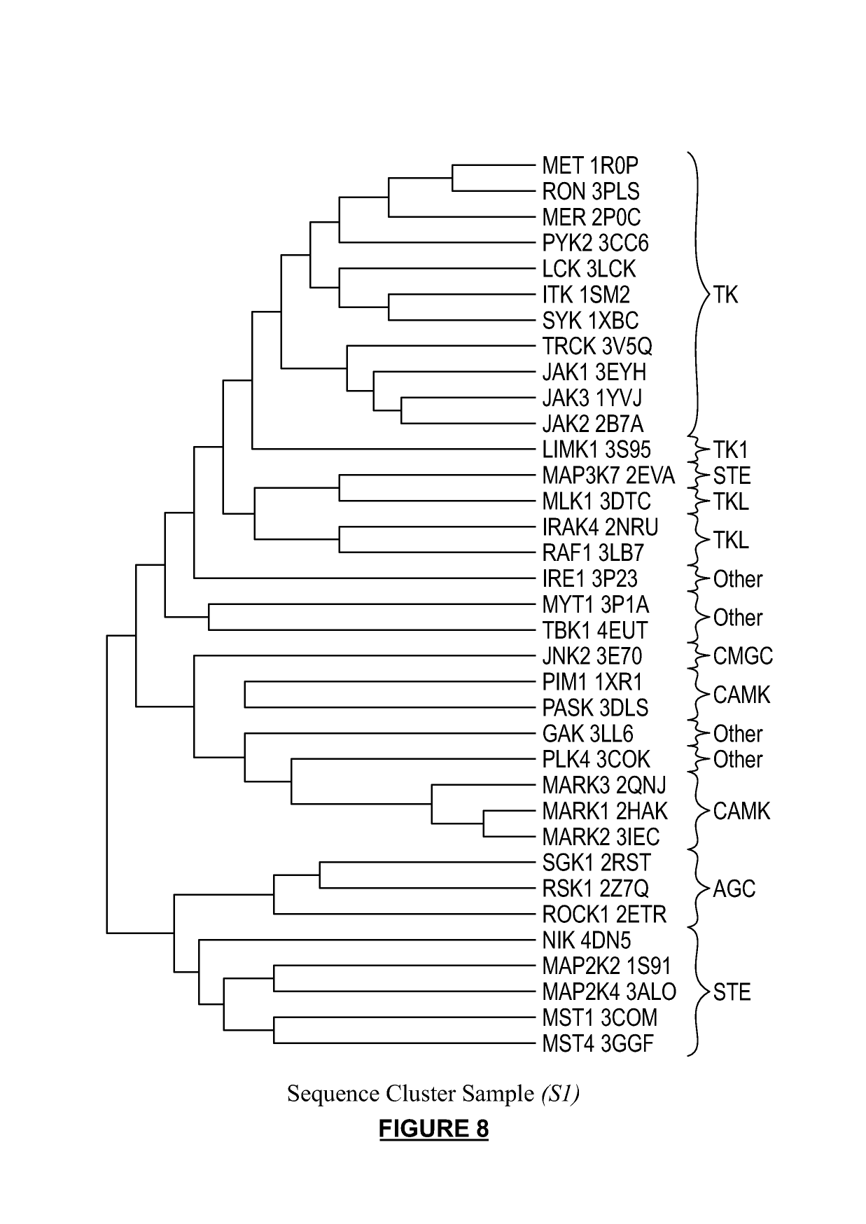

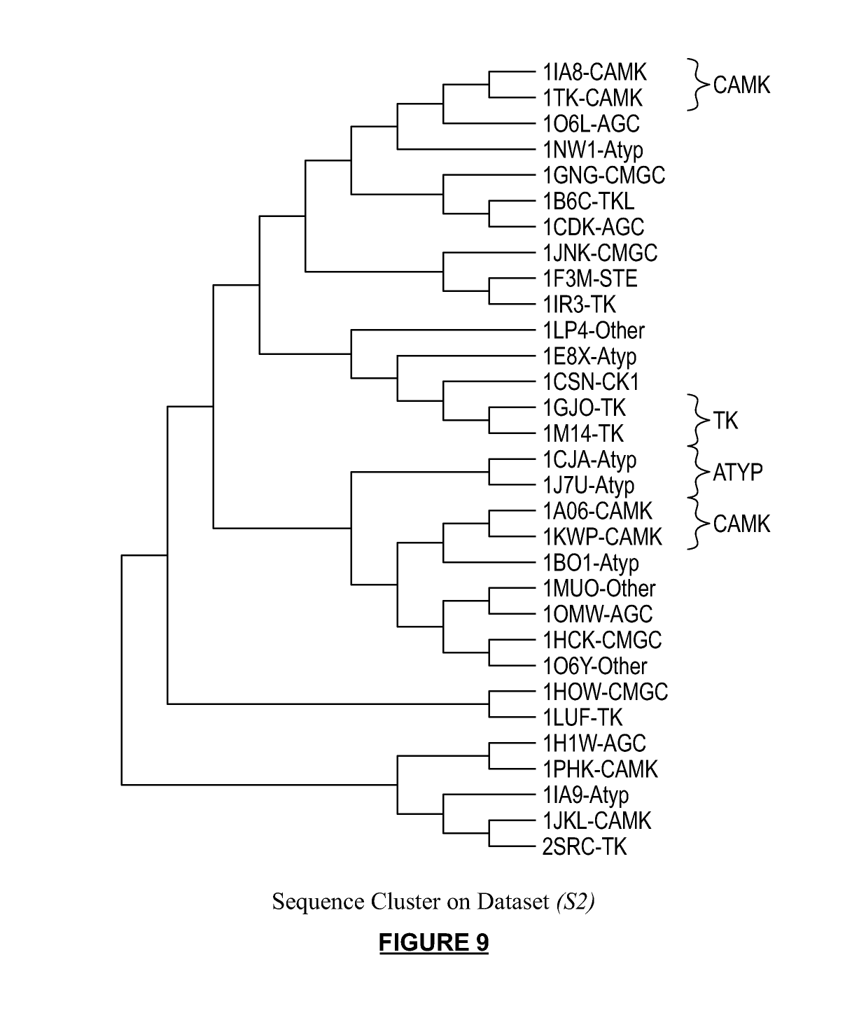

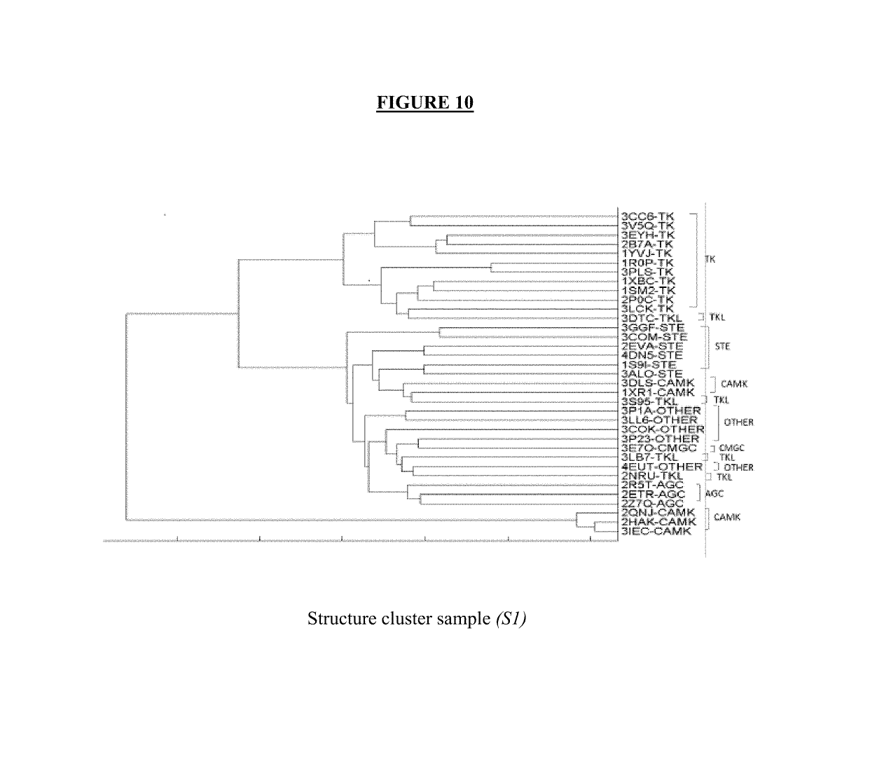

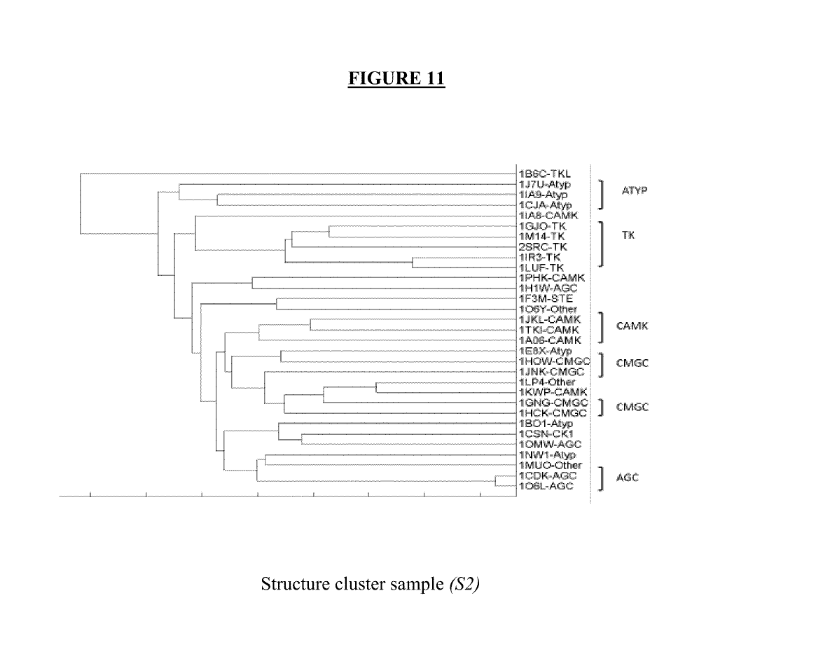

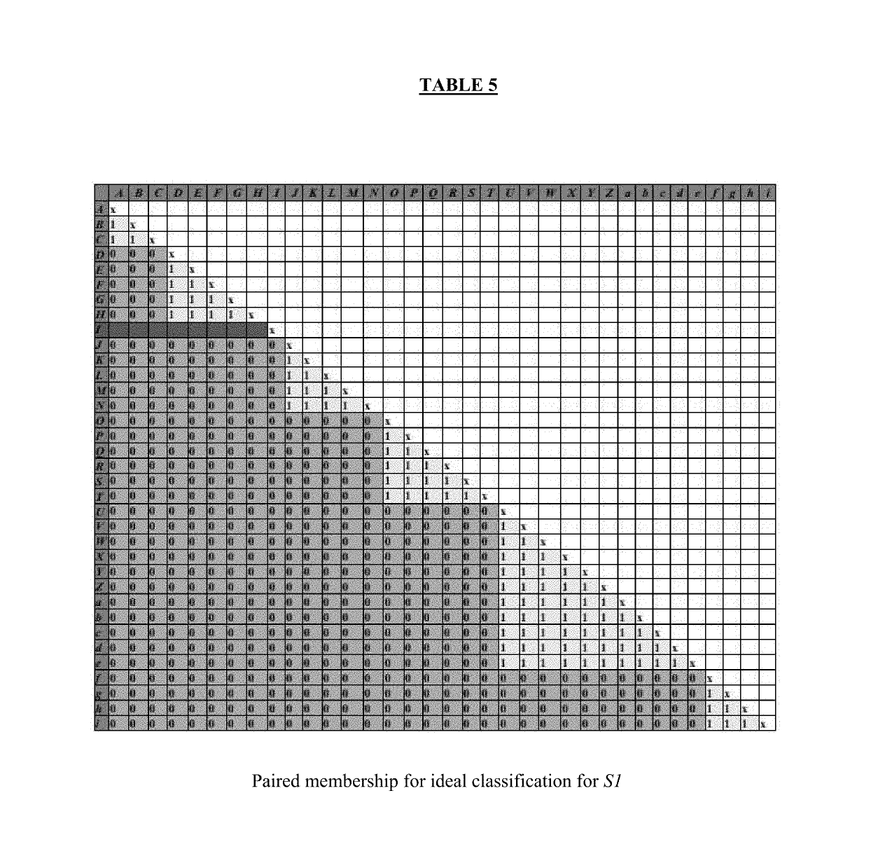

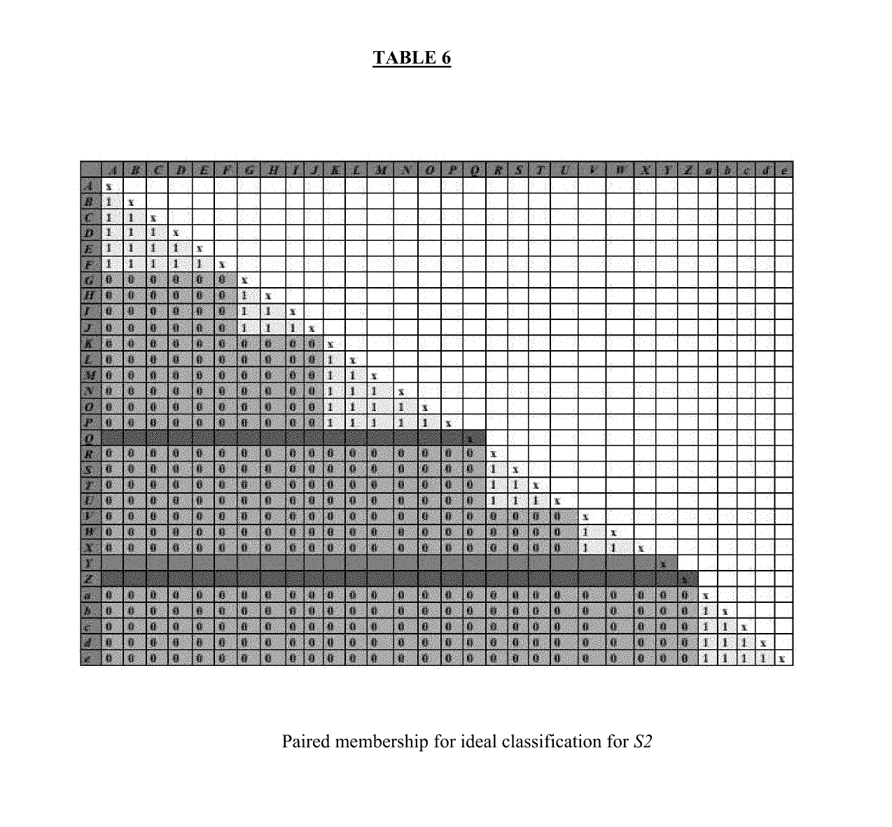

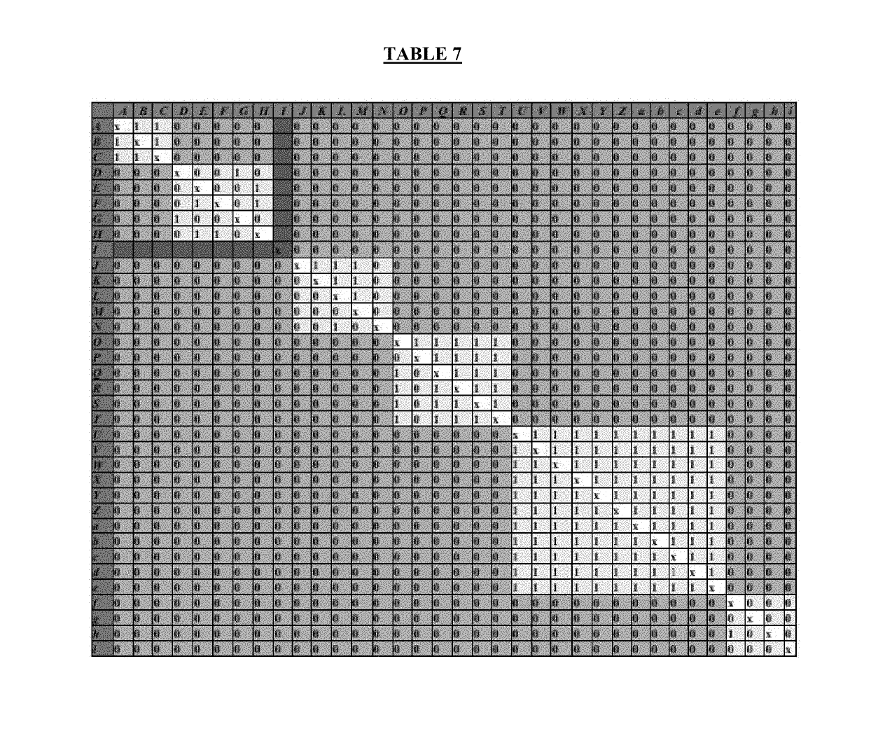

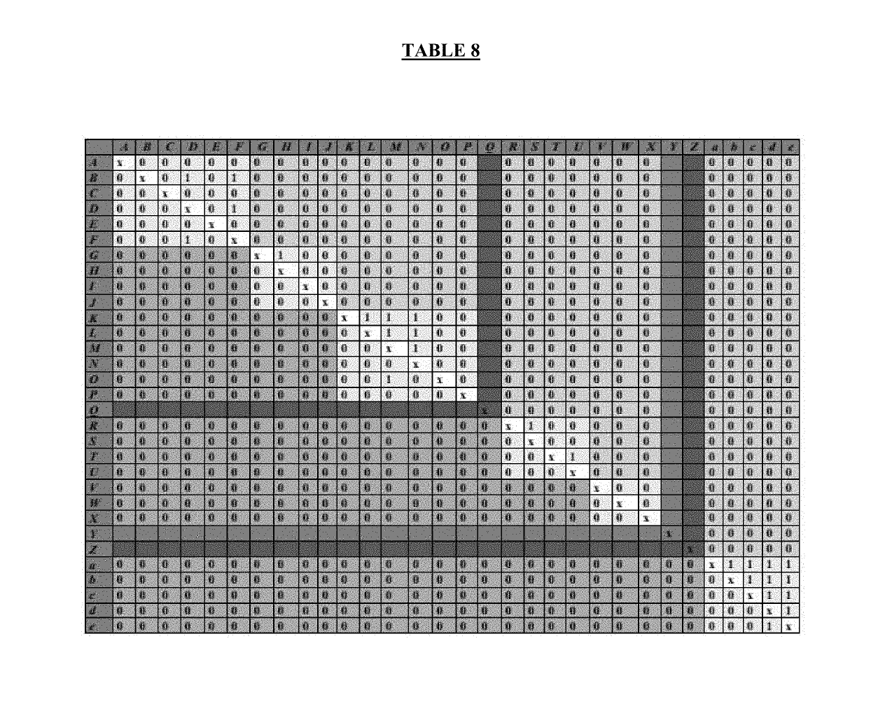

FIG. 8 (for S1) and FIG. 9 (for S2) show the results of the phylogeny trees constructed after sequence alignment. FIG. 10 (for S1) and FIG. 11 (for S2) give the structural clusters formed using MAD keys. The “good clusters” are specified after the square brackets.

The evolutionary grouping of protein kinases are shown in Table 3 and Table 4. The “good clusters” described in FIG. 8, FIG. 9, FIG. 10 and FIG. 11 rely on this prior knowledge and indicate the groups with members that belong together in the ideal cluster.

The paired cluster membership Ø for ideal classification for sample S1 is given in Table 5 and in Table 6 for S2. These cluster memberships are derived from the functional grouping discussed in Table 3 and Table 4. All pairs with membership value of 1 belong to same cluster and those with membership value of 0 belong to different clusters. The rows and columns in Table 5 and Table 6, indicate the protein index, given as serial number (column 1) in Table 3 for S1 and Table 4 for S2.

The ideal classification given in Table 5 for sample S1 is compared to the classification obtained by sequence clusters given in FIG. 8 and structure cluster given in FIG. 10. Similarly, the ideal cluster for sample S2 as given in Table 6 is compared to the sequence cluster for S2 given in FIG. 9 and structure cluster for S2 given in FIG. 11. The results of this comparison are presented in Table 7 and Table 8. The rows and columns of these Tables indicate the protein index for the respective samples.

The comparison of sequence and structure clusters with the ideal clusters for the given samples is performed using the concept of paired membership. For each protein pair as given by the row and column, if in the sequence cluster, its membership is found to be same as the ideal cluster, the pair is given a value of 1, otherwise it is given a 0. A pair is considered to have same cluster membership when they are in same class in both classifications or are in different classes in both classifications. For the simplicity of representation, only those pairs that are expected to be in same class in the ideal cluster are evaluated.

### Cluster Evaluation

Structure is more conserved evolutionarily than sequence is conserved. Structure clusters should, therefore, be closer to the ideal cluster in comparison to sequence cluster. Table 7 and Table 8 give the paired membership for clusters obtained by sequence as well as structure clustering methods for samples S1 and S2. The lower triangular matrices in the Tables mentioned above is of sequence classification and the upper triangular matrix is of structure classification. Evaluation is made with respect to pairs of interest and not all pairs. Interesting pairs are ones that have a paired membership value of 1 in the ideal classification. Similarity (“SIM”) is calculated between sequence classification and ideal, and structure classification and ideal. SIM is given by Equation 9, where Pᵢ, is defined as those pairs of objects that belong to same group

$$SIM = \frac{\vert {P}_{r} \vert}{\vert {P}_{i} \vert} \vert SIM ∈ [ 0 , 1 ] \qquad Equation 9$$

in the ideal classification or can be called the ‘interesting pairs’. And Pᵣ is the set of similarly clustered instances from the “interesting pairs” with respect to “good clusters” as given in FIG. 8, FIG. 9, FIG. 10, and FIG. 11. Comparison between the sequence based cluster/tree and structure based cluster/tree is made with respect to the “goodness” of clustering according to Equation 10:

k=Pᵢ(y)

k*=Pᵣ(y*)

k**=Pᵣ(y**)

c*=SIM(k*,k)

c**=SIM(k**,k) Equation 10

where, y is the ideal classification, y* and y** are two classifications under examination. Here y* will be considered a better classification/tree if c*>c**, as y* is closer to ideal, or vice versa. For the calculation purpose, all the objects in a sample that resulted in singleton cluster in the ideal cluster were not included—i.e., all the objects of classes which have no more than one object were ignored.

Table 9 below compares the structural classifications with ideal, and sequence classification with ideal. Sample S1 has similarity value of 0.75 to ideal for sequence clustering, and 0.83 to ideal for structure clustering. For homologous human kinase proteins in sample S1, the structure clustering using MAD selected TSR 3-D keys outperforms sequence clustering, but the difference between the similarity values is relatively low.

TABLE 9
Comparison of clustering methods

| | S1 | | S2 | |
|---|---|---|---|---|
| \|Pi\| | 99 | | 55 | |
| | Sequence | Structure | Sequence | Structure |
| \|Pr\| | 74 | 82 | 3 | 22 |
| Similarity with | 0.75 | 0.83 | 0.054 | 0.40 |
| ideal (SIM) | | | | |

For sample S2, the similarity for sequence clustering to ideal is 0.054 or 5.4%. The similarity of structure clustering to ideal is 0.40 or 40%. Although, these similarity values are much less compared to those seen for S1, structural clustering using MAD selected TSR 3-D keys completely outperforms the sequence.

### Use in Structural Motif Discovery

Keys that fulfill the MAD criteria can be used to find structural motifs. Some of these evolutionarily conserved sub-structures may be found in sequence alignment. Structural motifs can be defined by its smallest TSR 3-D unit that is by a triple of amino acid, or by longest sub-structure. In both the cases the amino acids being represented by the sub-structure of interest, may or may not be continuous in the sequence.

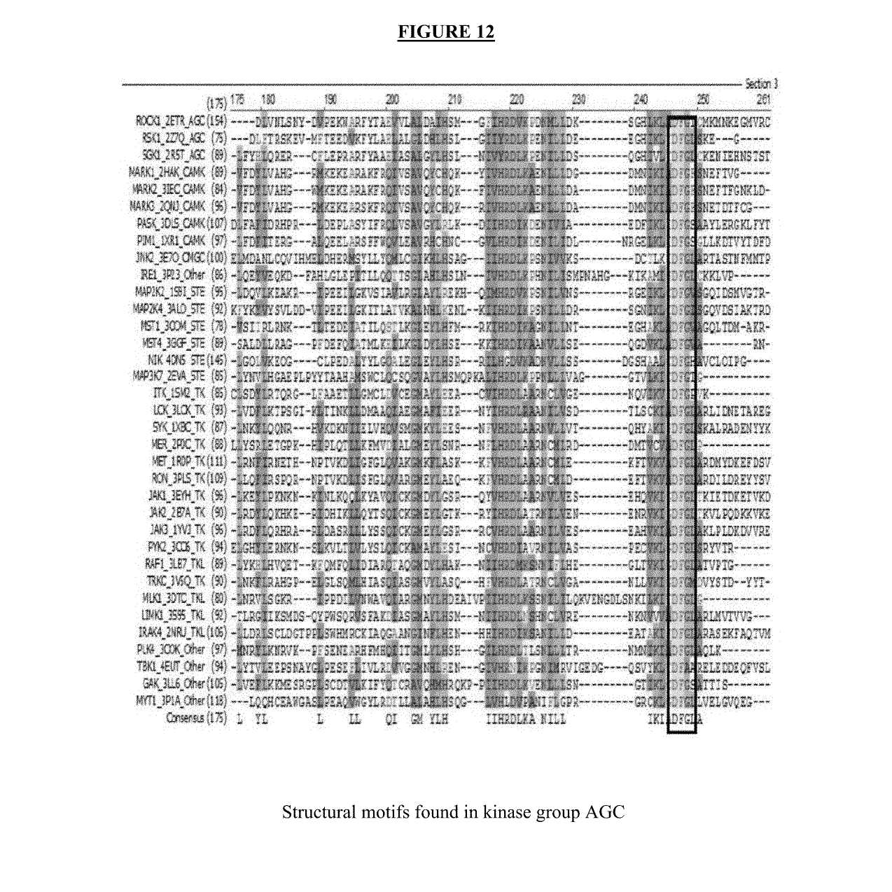

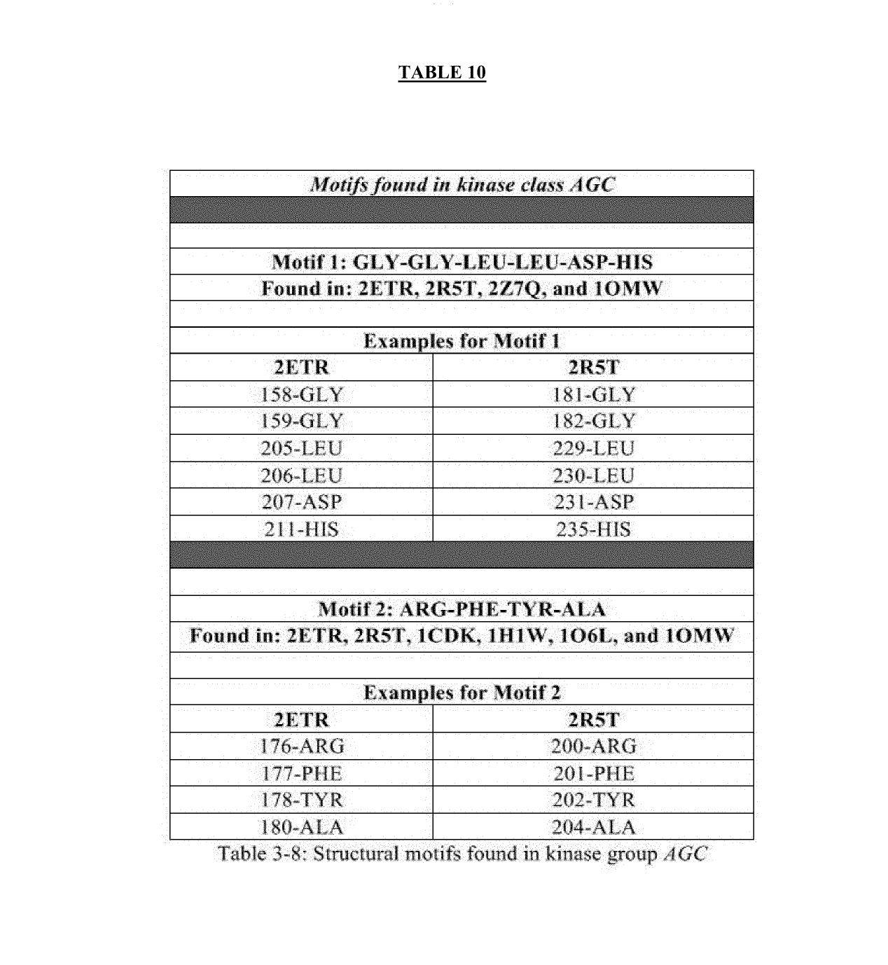

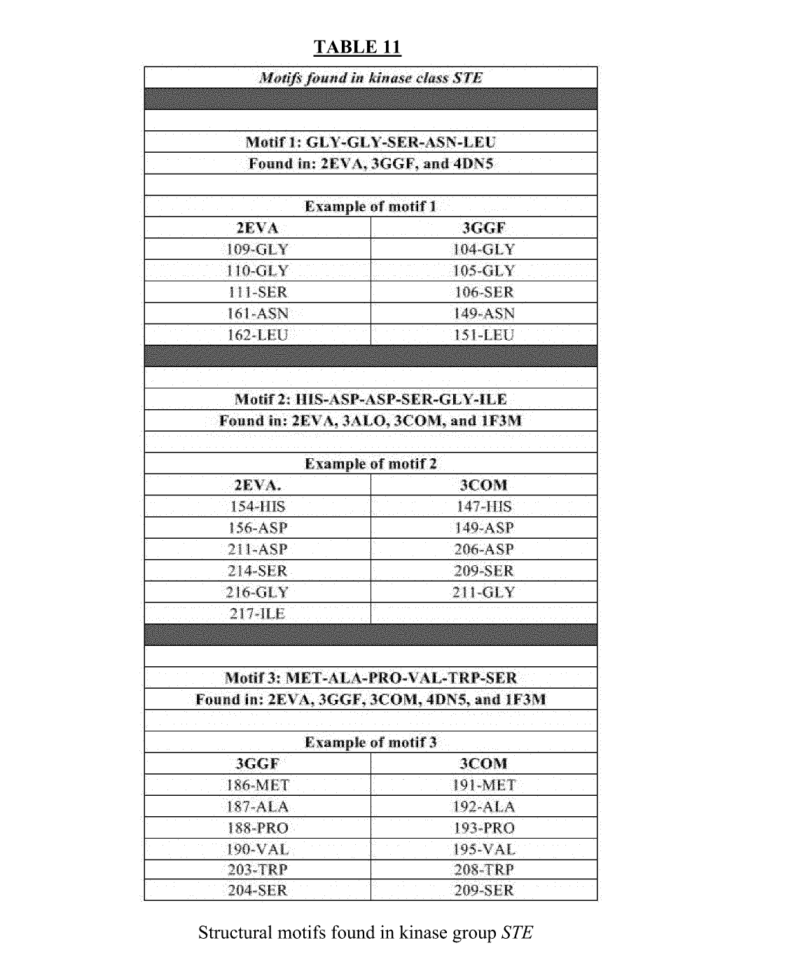

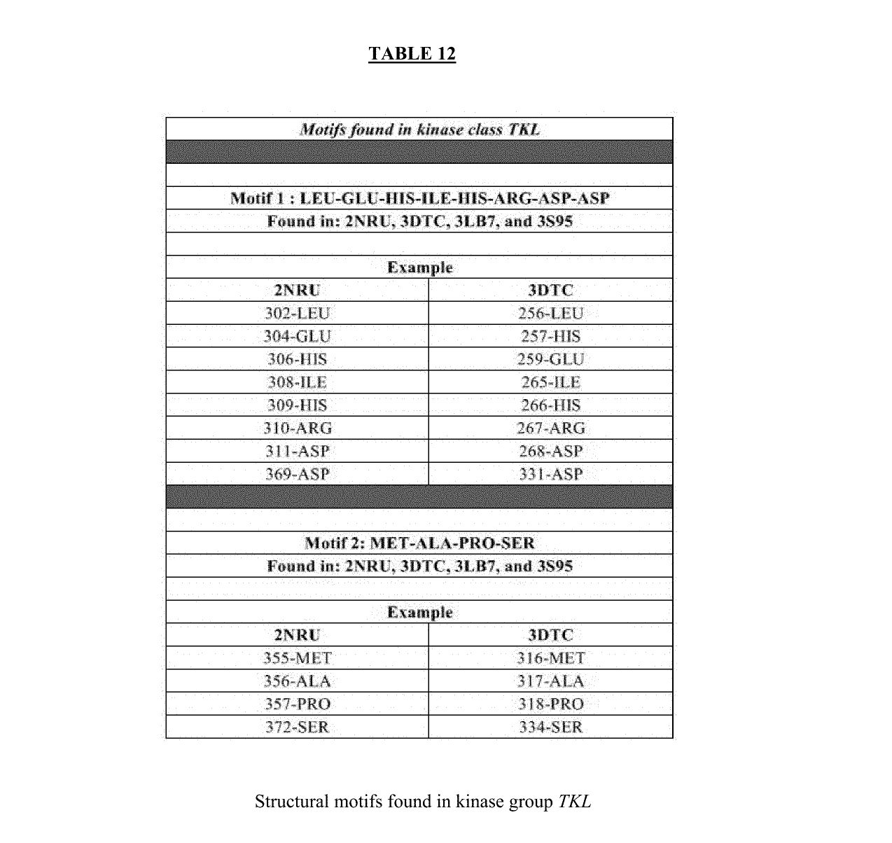

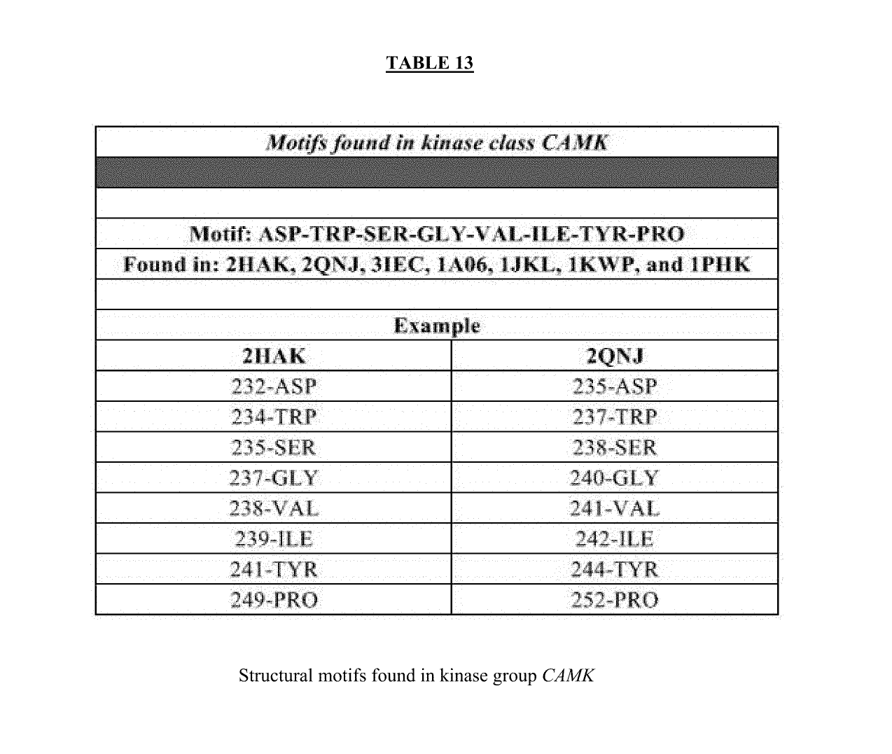

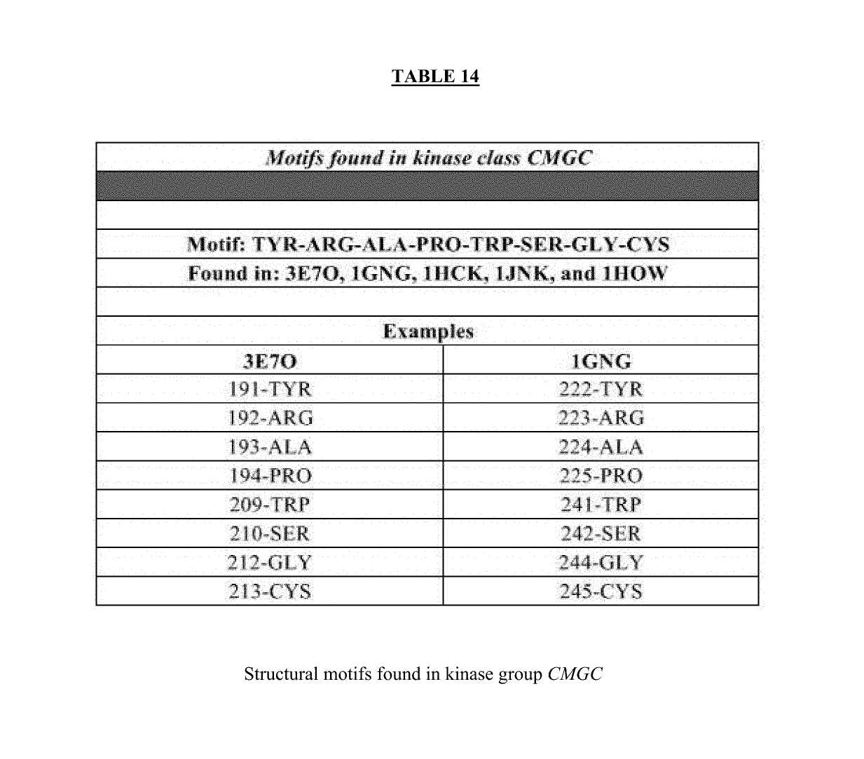

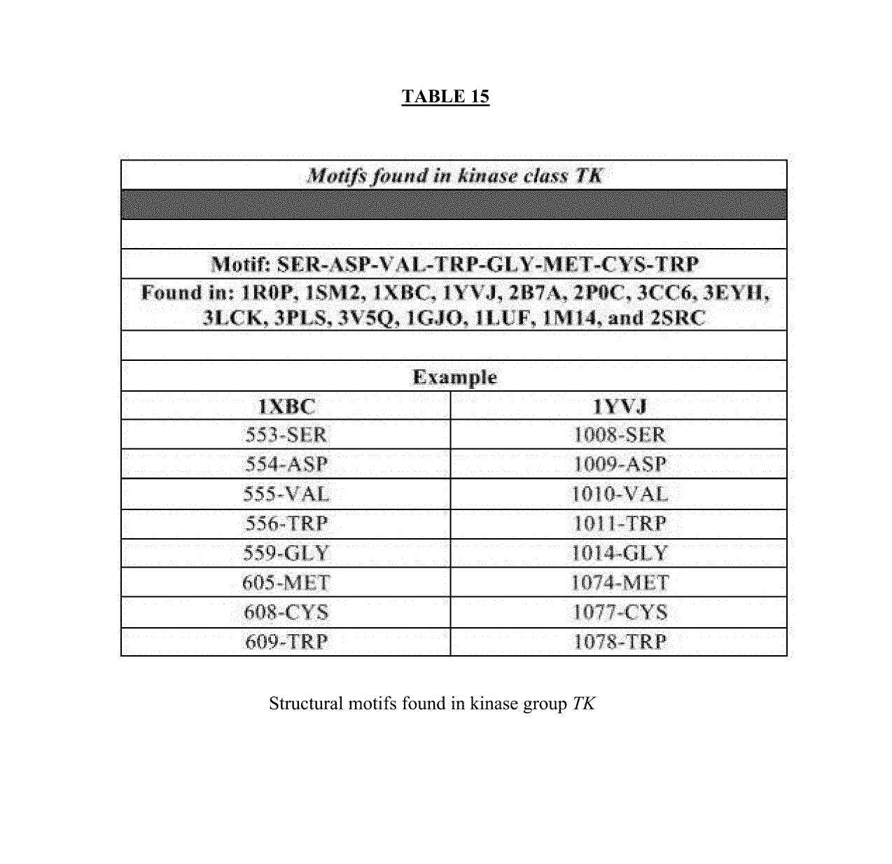

Take for example, the DFG motif (FIG. 4) which is found in protein kinase. DFG is an evolutionarily conserved triple of amino acids that can be seen in sequence alignment. The conserved triple is seen in sequence alignment FIG. 12.

It may also be desirable to find larger motifs or to focus on subgroups within the protein. Protein kinases can be grouped into various classes based on several criterion as shown previously. Longest sub-structure from locally conserved sub-structures for a given class of kinase could give insights into various motifs that may be longer than three amino acids. Algorithm 4 is used to find the structural motifs from longest sub-structure.

In Table 10, Table 11, Table 12, Table 13, and Table 14, and Table 15 the various structural motifs found in kinase classes, AGC, STE, TKL, CAMK, CMGC and TK, respectively are shown. These motifs may be non-contiguous in the sequence. So, these Tables give the examples of proteins and the position of the motifs in the sequence.

### Example Conclusions

The comparison of key distribution between randomly selected keys and locally selected keys revealed that the differences lie in the distribution of length. The locally selected keys are concentrated between 0 and 10 angstrom implying that the functional groups are more closely placed in the space. The cluster analysis between sequence and structure emphasizes that the structural classification is closer to the ideal classification compared to the sequence-based classification.

### Multi-Class Hierarchical Classification

The instant method can also be used in some embodiments for hierarchical protein classification; each level in the hierarchy can have several labels and may have some structural variation. Proteins have a natural structural hierarchy, thus any protein structure comparison or alignment algorithm must have the ability to perform protein classification. The evolutionary, structural, and functional distance between two proteins determines the structural hierarchy. There may be several parts of the proteins that are structurally and functionally independent with respect to the rest of the protein. Such functionally-independent sections of a protein are called domains. In some applications, the classification of protein domains into their respective hierarchical classes is of greater interest than classifying the entire protein, due to their conserved functionality. TSR 3-D-based structural hashing provides a representation of structural nuances of the proteins. And the TSE 3-D keys can be used as the protein attributes for producing correct hierarchical classification of the domain structures.

Most previously-known classifiers are designed for binary classification tasks and none can directly handle hierarchical classification. Multi-class hierarchical classification has previously been handled as a combination of several flat-binary classifiers. Flat classification is the simplest and most commonly used approach to classify protein structures. It simulates hierarchical classification, but does not retain the hierarchical information.

Performance of TSR 3-D is comparable to several other methods in flat-protein structure classification. However, to overcome the inherent shortcomings of flat classification, a new method, Attribute Selected—Local Classifier per Parent Node (“AS-LCPN”), is described herein. This method performs attribute selection based on decision tree at every node, including the root node. The hierarchical classification outperforms flat classification by at least 1.3% average accuracy.

In this embodiment, TSR 3-D is used to define structural units for each protein domain, as explained previously. Key generation function is used to generate unique keys for each structural unit. The entire protein domain is then represented by a set of triples of key-value pairs. The key captures some structural characteristic and the value is the number of times that key occurs in a given protein. It is desirable to use these representative keys for each domain to effectively perform structural classification of protein domains. “Class” as a variable in the hierarchical classification is referred to a group of structurally or functionally related proteins not necessarily of common evolutionary origin.

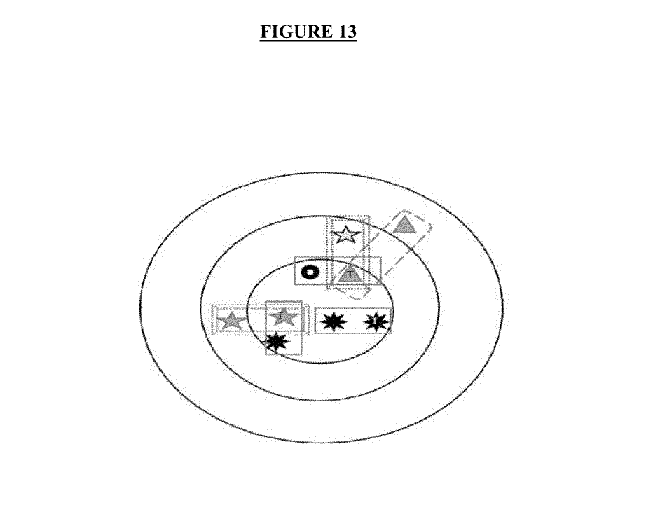

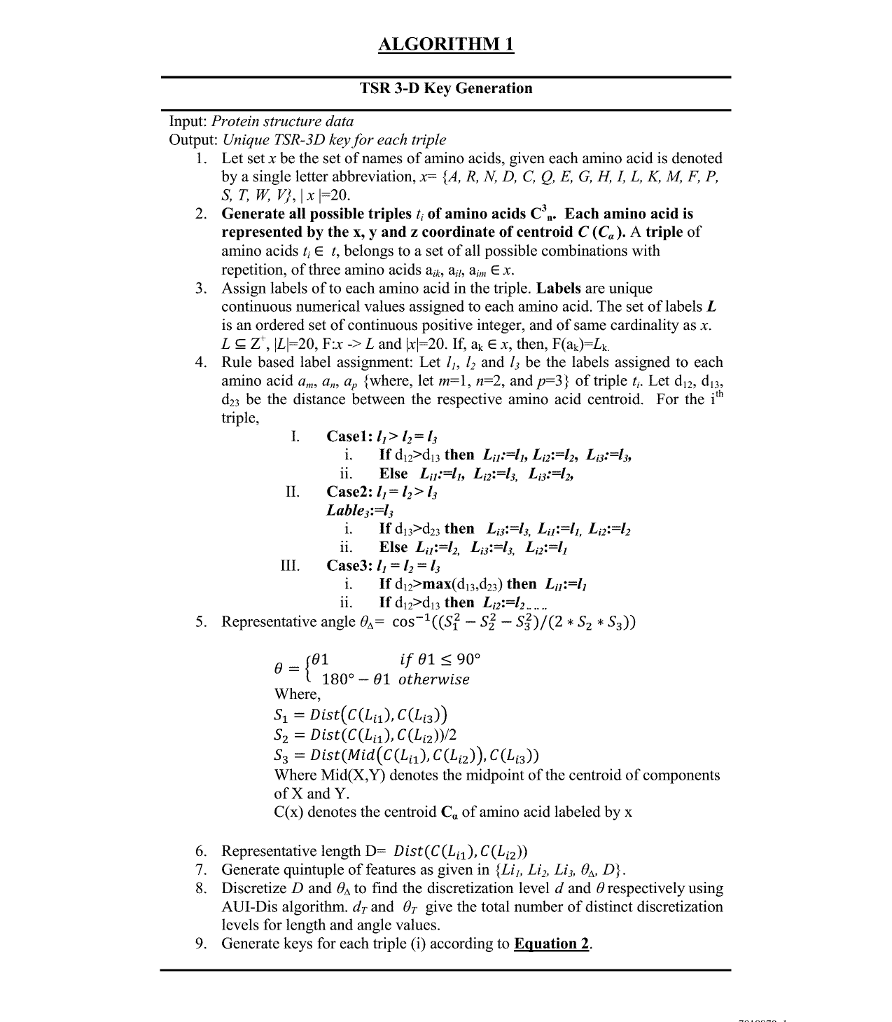

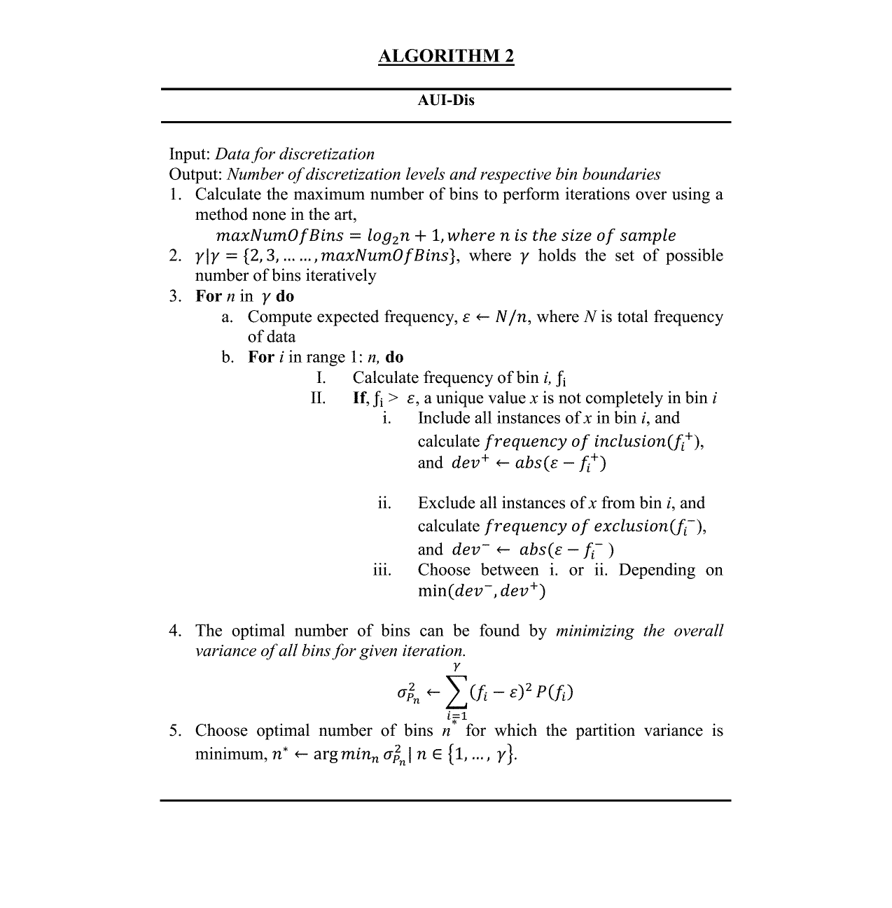

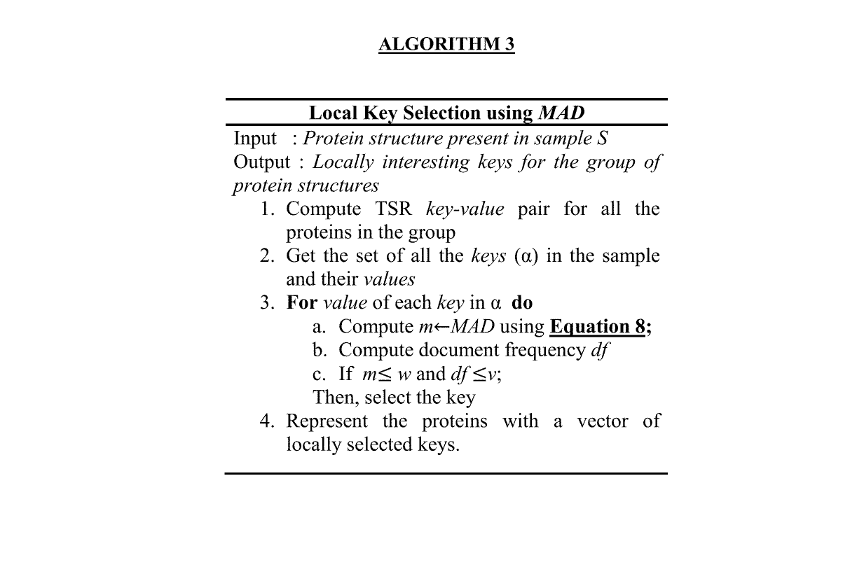

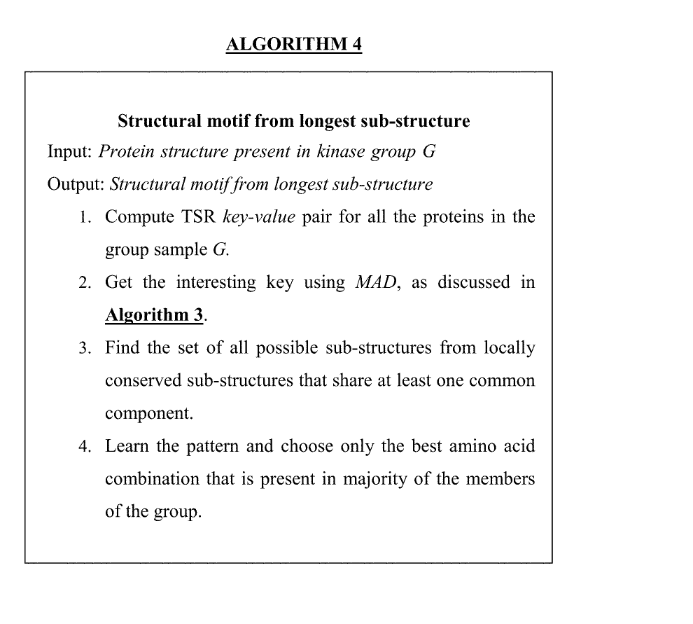

For classification the cross-validated k-nearest neighbor algorithm as known in the art and as illustrated in FIG. 13 is used. Turning to the FIG. 13, TOP 1, TOP 2, TOP 3 represent the search. Objects with (T) marking are test instances. For black star, the instance with correct class is in TOP 1 of the search. For five-point grey star, the instance with correct class is in TOP 2 of the search. For grey triangle the instance with correct class is in TOP 3 of the search.

Let c(test) be the class of test instance, c(train)(1), c(train)(2), c(train)(3) be the classes of training instance ranked 1, 2, and 3 respectively. A test instance is considered correctly classified if For k=1, c(test) is found in c(train)(1); For k=2, c(test) is found in c(train)(1) or c(train)(2); For k=3, c(test) is found in c(train)(1) or c(train)(2) or c(train)(3).

For the purpose of understanding the Method and System for Comparing Proteins in Three Dimensions, references are made in the text to exemplary embodiments of a Method and System for Comparing Proteins in Three Dimensions, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

Reference throughout this specification to features, advantages, or similar language does not imply that all of the features and advantages that may be realized should be or are in any single embodiment. Rather, language referring to the features and advantages is understood to mean that a specific feature, advantage, or characteristic described in connection with an embodiment is included in at least one embodiment. Thus, discussion of the features and advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the method or system may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

1. A method for analyzing the three dimensional structures of a protein comprising the steps of:
a. assigning a unique numerical value to three non-collinear objects within said protein, and
b. computing at least one key of said protein wherein each said at least one key is based on a quintuple of features consisting of three labels of said three non-collinear objects in said protein, a representative angle between said three non-collinear objects, and a representative edge length.

2. The method of claim 1 wherein said three non-collinear objects comprise amino acids.

3. The method of claim 2 wherein each of said amino acids in a triple is not distinct.

4. The method of claim 1 wherein a structural similarity map is generated using said at least one key in a pairwise structure comparison method.

5. The method of claim 1 wherein said representative angle and said representative edge length are discretized using an unsupervised equal frequency binning method.

6. The method of claim 5 wherein said unsupervised equal frequency binning method is Adaptive Unsupervised Iterative-Discretization.

7. The method of claim 2 wherein a structural representation is created that incorporates primary structure information from said amino acid sequences and three dimensional information through said representative angle and said edge length.

8. The method of claim 1 wherein said computing step is performed by a transformation function.

9. The method of claim 8 wherein said transformation function is deterministic.

10. The method of claim 8 wherein said transformation function is sensitive to scaling.

11. The method of claim 8 wherein said transformation function is invariant to rotation and translation.

12. The method of claim 1 wherein said at least one key is an integer.

13. The method of claim 2 wherein said computing step incorporates the natural semantic categorization of said amino acids.

14. The method of claim 13, wherein said three non-collinear objects comprises atoms within said amino acids.

15. The method of claim 1 wherein Mean Absolute Deviation (“MAD”) criterion are employed to select said at least one key based on structural clusters, and applying sequence and structural motif comparisons to a known database to determine structural motifs.

16. The method of claim 15 wherein, said structural motifs are used to generate hierarchical classification of said proteins.

17. A method for comparing the three dimensional structures of proteins comprising the steps of developing at least one key for each of two or more proteins, wherein each said at least one key is based on a quintuple of features consisting of three non-collinear objects in said proteins, a representative angle between the three non-collinear objects and a representative edge length, and applying pairwise protein 3-D structure comparison method using said at least one keys to generate a structural similarity map.

18. A method for analyzing three dimensional structures comprising the steps of:
a. assigning a unique numerical value to three non-collinear objects within said three dimensional structure, said three non-collinear objects form a triangle comprising three vertices and a centroid of each said vertices,
b. generating all possible triples of said three non-collinear objects wherein each said three non-collinear objects is represented by the three dimensional coordinates of said centroid,
c. arranging said non-collinear objects by rule-based assignment,
d. calculating a representative angle,
e. calculating a representative edge length,
f. generating a quintuple of features consisting of said unique numerical value of said three non-collinear objects, said representative angle, and said representative edge length,
g. discretizing said representative angle and said representative edge length, and
h. generating at least one key based on said quaintuple of features.

19. The method of claim 18 further comprising the step of using MAD criterion to select said at least one key.

20. The method of claim 18 wherein said discretizing step is performed by Adaptive Unsupervised Iterative-Discretization.

21. The method of claim 18 wherein said three dimensional structure is a protein.

22. The method of claim 21 where said three non-collinear objects are selected from the group consisting of amino acids and amino acid atoms.

23. The method of claim 22 further comprising the step of applying pairwise protein 3-D structure comparison using said at least one key to generate a structural similarity map.

24. The method of claim 21 further comprising the step of classifying proteins hierarchically using Attribute Selected—Local Classifier per Parent Node.
